(19) United States
(12) Patent Application Publication
(10) Pub. No.: US 2022/0141642 A1
(43) Pub. Date: May 5, 2022

(54) SYSTEM AND METHOD OF DISTRIBUTION OF ESIM PROFILES TO A PLURALITY OF ENTERPRISE ENDPOINT DEVICES

(71) Applicant: Dell Products, LP, Round Rock, TX (US)

(72) Inventors: Anantha K. Boyapalle, Cedar Park, TX (US); Venkata S. Prayaga, Austin, TX (US); Joseph Kozlowski, Hutto, TX (US); Carlton A. Andrews, Austin, TX (US); Liam B. Quinn, Austin, TX (US)

(73) Assignee: Dell Products, LP, Round Rock, TX (US)

(21) Appl. No.: 17/085,402

(22) Filed: Oct. 30, 2020

(51) Int. Cl. H04W 8/18; H04W 48/08

(52) U.S. Cl. CPC H04W 8/18; H04W 48/08

(57) ABSTRACT

An information handling system operating an enterprise endpoint embedded subscriber identification module (eSIM) provisioning system may comprise a processor, memory, and network interface device for transceiving data with an endpoint computing device having an embedded universal integrated circuit card (eUICC) capable of programmable selection among networks including at least one network in a 5G New Radio frequency band, the processor executing code of an enterprise client management (ECM) system for management of eSIM profiles for plural endpoint computing devices, the ECM system associating a unique hardware derived device IDentification based on hardware components of the endpoint computing device with a level of wireless service for the endpoint computing device based on enterprise allocation of service for the endpoint computing device via the ECM system, and the network interface device transmitting an eSIM profile to the endpoint computing device for implementation at the eUICC for the assigned level of service.

### FIELD OF THE DISCLOSURE

The present disclosure generally relates to information handling systems and more specifically relates to information handling systems that facilitate wireless connectivity via mobile broadband networks to authorized enterprise endpoint devices.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may conduct one or more forms of wireless network communication, including subscriber-based wireless communication.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram illustrating an enterprise endpoint eSIM provisioning system according to an embodiment of the present disclosure;

FIG. 3 is a block diagram illustrating an enterprise endpoint device according to an embodiment of the present disclosure;

FIG. 4 is a flow diagram illustrating a method of associating an enterprise endpoint device with an eSIM profile via an enterprise endpoint eSIM provisioning system according to an embodiment of the present disclosure;

FIG. 5 is a flow diagram illustrating a method of a RAN provider enabling an eSIM profile provisioned to an enterprise endpoint device via an enterprise endpoint eSIM provisioning system according to an embodiment of the present disclosure; and

FIG. 6 is a flow diagram illustrating a method of an enterprise endpoint device transceiving data using an eSIM profile provisioned via an enterprise endpoint eSIM provisioning system according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Information handling systems such as, for example, laptop/notebook computing devices, tablet computing devices, mobile phones, Internet of Things (IoT) computing devices, or other endpoint computing devices known in the art, often utilize wireless networks in order to enable mobility of those endpoint computing devices while exchanging data, as well as to exchange data from remote locations. Wireless networking technology has begun to transition from 4G millimeter wave (4G) wireless technology to 5G millimeter wave (5G) wireless technology. Current conventional 5G wireless technology improves upon previous generations of cellular technology by supporting remote provisioning of credentials required for end user devices, including enterprise endpoint devices (e.g., end user devices managed by an enterprise) to access the 5G networks operated by mobile broadband network operators.

Previous generations of wireless technology, such as 2G, 3G, 4G, and LTE have required information handling systems communicating according to these standards to include a subscriber identity module (SIM) card. The SIM card in information handling systems communicating according to these previous generational standards tracks the identity of the device accessing the cellular network. End user cellular information handling systems (e.g., smart phones) have previously incorporated SIM cards in the manufacturing stage of the device, with a separate SIM card required for access to each cellular network. Thus, the end user device is burdened with higher computing overhead and an increased size and weight due to inclusion of multiple SIM cards and related network interface devices.

The emerging 5G standard supports the storage of SIM credentials on end user devices as embedded SIM (eSIM) credentials, Internet of Things (IoT) SIM (iSIM) credentials, or Virtual SIM (vSIM) credentials. These eSIM credentials may be stored, within an eSIM profile, on an embedded universal integrated circuit card (eUICC) coupled to the mother board of the end user device, and accessible only in kernel mode. Such eSIM credentials may be stored at the end user device using an authenticated basic input/basic output (BIOS) interface in the form of an eSIM profile. A plurality of eSIM profiles, such as separate eSIM profiles for each of the mobile broadband networks or Radio Access Networks (RANs) the end user wishes to access may be stored on a single eUICC in an embodiment, such as within a secure flash memory. In previous cellular technology standards (e.g., 4G), this may only be achieved by including a plurality of SIM cards within the architecture of the end user device. Thus, the use of the eUICC in an embodiment may eliminate the need for the end user device to accommodate multiple SIM cards and their associated processing overhead. This results in smaller, more lightweight end user devices in embodiments described herein. Further, the device may be hermetically sealed (e.g., since the user does not need to insert or remove SIM cards during operation of the end user device), to be made more tolerant to environmental factors such as dampness, temperature, and vibration.

Further, the 5G standard may support the remote provisioning of these eSIM profiles for storage at the end user device eUICC, after the manufacture of the device. For example, eSIM profiles may be transmitted to an end user device using an authenticated basic input/basic output (BIOS) interface, for storage on the eUICC in kernel mode. Because these eSIM profiles are provisioned using the authenticated BIOS interface in kernel mode, the remote provisioning of eSIM profiles provides an equivalent level of security as the removable SIM cards of previous cellular technology standards.

Such remote provisioning of eSIM profiles in an embodiment may require some form of subscription management by the remote entity or infrastructure responsible for transmitting the eSIM profiles for storage at the end user device. There are two primary forms of subscription management architecture for 5G networks, including Machine to Machine (M2M) subscription management and consumer eSIM subscription management. The M2M subscription management architecture charges a remote M2M service provider with management, assignment, and delivery of eSIM profiles to end user devices. The M2M service provider in such an architecture may effectively “push” the eSIM profiles out to authorized end user devices for storage on their respective eUICCs. In contrast, the consumer eSIM subscription management architecture charges the end user device with requesting and managing eSIM profiles directly from the mobile broadband network provider. The end user device in such an architecture may effectively “pull” the eSIM profiles from the network provider, eliminating the need for an M2M service provider. This may be useful in situations where the end user device is owned and operated by an individual consumer that does not need to manage a plurality of devices. The M2M architecture is more useful in situations where a single entity or enterprise owns and manages a plurality of enterprise owned end user devices (e.g., enterprise endpoints) that each need to access cellular networks, including mobile employee information handling systems (e.g., laptops, or smart phones), or an ecosystem of IoT devices (e.g., meters, sensors). In order to manage access by each of these enterprise endpoints to cellular networks in a cost-effective manner, the enterprise owner of these enterprise endpoints may use an M2M service provider to orchestrate assignment, reassignment, and delivery of eSIM profiles, from a pool of eSIM profiles purchased by the enterprise owner, to the enterprise endpoints on an as-needed basis. Embodiments of the present disclosure may focus on the M2M architecture.

The emerging 5G standard's support for remote delivery of eSIM profiles from an M2M service provider to an end user device presents an opportunity to optimize use of eSIM profiles across a plurality of end user devices owned or managed by a single entity, such as an enterprise business. The enterprise endpoint eSIM provisioning system in embodiments of the present disclosure may operate, at least partially, as such an M2M provider to enable such optimization. In embodiments of the present disclosure, the enterprise owner of a plurality of enterprise endpoint devices may include the enterprise endpoint eSIM provisioning system of an enterprise client management (ECM) system, (e.g., a cloud client management (CCM) platform), operating as the M2M service provider via one or more management servers, to manage assignment and delivery of a pool of eSIM profiles, purchased by the enterprise, to the plurality of enterprise endpoint devices.

Enabling a single platform or system to manage the eSIM profiles for each of the enterprise endpoint devices in such a way may allow for optimized use of each of the eSIM profiles within the purchased pool. For example, some enterprise endpoint devices may be mobile and need to access a plurality of mobile broadband networks or RANs during travel, during operation of different applications, or access by different users, such that a signal meeting minimum service level requirements for the operational conditions can always be accessed. In such an example embodiment, the enterprise endpoint eSIM provisioning system may issue a plurality of eSIM profiles to a single mobile enterprise endpoint device, with each of the plurality of eSIM profiles granting that single mobile enterprise endpoint device access to a separate mobile broad band network in the 5G or 4G protocols (e.g., SPRINT®, T-Mobile Verizon®, or AT&T®) under various operating condition circumstances.

In another example, some enterprise endpoint devices may only require access to a single mobile broadband network or RAN (e.g., SPRINT®), because that is the only network available at that enterprise endpoint device's location and capable of meeting that enterprise endpoint device's service level requirements. In such an example embodiment, the enterprise endpoint eSIM provisioning system may assign only one eSIM, from a pool of eSIM profiles purchased by the enterprise from SPRINT, rather than assigning, by default, one eSIM profile from each of the pools purchased by the enterprise from each of the available network carriers (e.g., SPRINT, T-Mobile, AT&T, Verizon) to every enterprise endpoint device.

In still another example, an enterprise endpoint device may routinely travel between two geographic locations, each receiving a strongest signal from a separate mobile broadband network or RAN provider. More specifically, an employee in possession of the enterprise endpoint device may routinely travel, on a known schedule, from a first office, where AT&T® has the best coverage, to a second office, where Verizon® has the best coverage. In such an example embodiment, the enterprise endpoint eSIM provisioning system may operate to assign and transmit to the enterprise endpoint device the eSIM profiles from the pool of profiles purchased from AT&T®, just prior to the scheduled travel to the first office (or upon request by the employee just prior to her travel to the first office). Upon the employee's departure from the first office to the second office, the enterprise endpoint eSIM provisioning system in such an embodiment may revoke the AT&T® eSIM profile assigned to the enterprise endpoint device, and assign and transmit to the enterprise endpoint device the eSIM profile from the pool of profiles purchased from Verizon®. This additionally allows the enterprise endpoint eSIM provisioning system to reassign the revoked AT&T® eSIM profile to another enterprise endpoint device currently exhibiting a greater need for access to the AT&T® network. In such a way, the enterprise endpoint eSIM provisioning system may distribute the plurality of eSIM profiles from a plurality of network providers across an ecosystem of enterprise endpoint devices owned by a single enterprise in a cost-effective manner, based on current needs of each of the enterprise endpoint devices.

The enterprise endpoint eSIM provisioning system operating as an M2M service provider in embodiments described herein may also optimize distribution of eSIM profiles among a plurality of enterprise endpoint devices, based on service level requirements (e.g., as defined by service level agreements (SLAs) associated with each end user device). For example, some enterprise endpoint devices may be associated with SLAs requiring access to greater bandwidth, fewer dropped packets, or other network connection requirements than SLAs associated with other enterprise endpoint devices. This may be the case, for example, when one enterprise endpoint device is intended for use in executing demonstrations (demos) requiring high-performance network connections, while another enterprise endpoint device (e.g., smart phone) is intended for use within the enterprise mainly for telephone and e-mail communications. Such operating conditions of reported software applications may determine between 4G, 5G, WiFi, or other networks, depending upon availability.

The ECM system in an embodiment may receive high-level network connectivity metrics from each of the enterprise endpoint devices managed by the enterprise during routine out-of-band communications between the ECM system and all enterprise endpoint devices. Such out-of-band communications may be used to check security credentials or performance statistics for the enterprise endpoint devices, or to push software or firmware updates to the enterprise endpoint devices, for example. During such routine maintenance, the ECM system may accumulate, sort, and analyze all performance metrics received from all enterprise endpoint devices, including network connectivity metrics and an identification of the network through which such connectivity is maintained. Based on this information, the enterprise endpoint eSIM provisioning system operating in tandem with or at the ECM system in an embodiment may generate a high-level estimation of connectivity metrics for each of the networks from which the enterprise has purchased one or more eSIM profiles. The enterprise endpoint eSIM provisioning system may take these connectivity metrics into account when assigning eSIM profiles to a requesting enterprise endpoint device, in order to optimally match end user device SLAs and network connectivity metrics associated with a given eSIM profile. Further, managed endpoint devices may check-in with the ECM system management servers in embodiments herein, with hardware derived device IDentification as well as reports of operation conditions or anticipated operation conditions for the managed endpoint devices. The endpoint device check-in accesses may be via a boot-strap, alternative wireless network such as Wi-Fi, or via wired connection. These operation conditions or anticipated operation conditions may be used to determine a type of wireless RAN or wireless service level to be assigned to an endpoint device. Managed endpoint device check-ins may be required periodically or when a boot-strap connection is available.

Security associated with the transfer of eSIM profiles to enterprise endpoint devices in an embodiment may be strengthened by requiring the enterprise endpoint device to identify itself using the hardware derived device ID assigned to and physically drawn from one or more hardware components (e.g., motherboard) of the managed enterprise endpoint device prior to assignment of an eSIM profile. Such a hardware derived device ID may be generated during manufacture of the enterprise endpoint device, where the one or more hardware components (e.g., motherboard) is combined with an embedded Universal Integrated Circuit Card (eUICC). Each eUICC placed into an enterprise endpoint device in such a way may also be associated with a unique identification applied by the eUICC manufacturer, and relayed to the enterprise endpoint eSIM provisioning system at a management server, prior to placement of the eUICC within the enterprise endpoint device. The hardware derived device ID in embodiments described herein may be generated based on a serial number or other identification code of at least one hardware component installed within the managed endpoint computing device. In some cases, the hardware derived device ID may be generated based on a combination of serial numbers from a plurality of hardware components, potentially including the eUICC unique identification, or an encryption of a serial number or combination of serial numbers. In still other cases, the hardware derived device ID may also be based on a device model number, revision number, serial numbers for certain applications loaded thereon, or upon an identification of the user logged onto the enterprise endpoint device.

Upon final compilation of the eUICC and the motherboard (or other hardware associated with serial numbers or other identifying codes) into a single enterprise endpoint device, the enterprise endpoint eSIM provisioning system in an embodiment may store an association between the hardware derived device ID, and the eUICC identification supplied by the eUICC manufacturer. The enterprise endpoint eSIM provisioning system in an embodiment may require an enterprise endpoint device requesting assignment of an eSIM profile to first provide the eUICC identification for that enterprise endpoint device and the hardware derived device ID that matches the hardware derived device ID associated with the eUICC identification provided, and as stored at the enterprise endpoint eSIM provisioning system at the management servers. The eUICC identification and the physically applied hardware derived device ID may be accessible by the enterprise endpoint device itself only in kernel mode in an embodiment. Further, operational condition indicators may be required including location, software operation, data being accessed, or an identification of the user currently logged onto the device. Thus, in order for the enterprise endpoint device to receive eSIM profiles, it must provide information accessible to it only in kernel mode. This enhanced security may inhibit the ability to “spoof” or counterfeit hardware derived device IDentifications in order to cause the enterprise endpoint eSIM provisioning system to assign eSIM profiles to unauthorized devices not owned or managed by the enterprise. Any change to hardware of the managed endpoint device seeking access will return an erroneous hardware derived device ID.

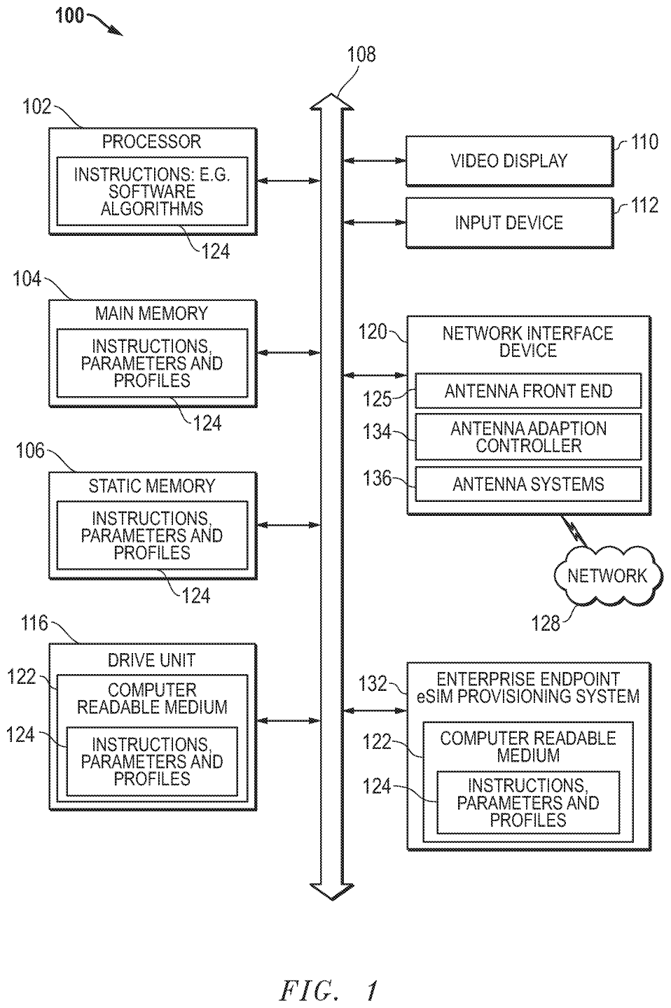

FIG. 1 illustrates an information handling system 100 according to several aspects of the present disclosure. The information handling system 100 as illustrated in FIG. 1 may be communicatively coupled to a Wireless Wide Area Network (WWAN) cellular network 128 through the use of embedded subscriber identity module (eSIM) credentials provisioned by an enterprise endpoint eSIM provisioning system operating in tandem with or at an enterprise client management system (e.g., a cloud client management (CCM) platform). In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), a server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a tablet computer, a desktop computer, an augmented reality system, a virtual reality system, a communications device, an access point (AP), a base station transceiver, a wireless telephone, a control system, a camera, a scanner, a printer, a pager, a personal trusted device, a web appliance, or any other suitable machine capable of executing a set of instructions (sequential or otherwise) that specify actions to be taken by that machine, and may vary in size, shape, performance, price, and functionality. The information handling system 100 of FIG. 1 may be a managed endpoint device according to some embodiments. In other embodiments, the information handling system 100 may operate as one or more management servers operating an ECM system. In further embodiments, the information handling system 100 may operate as a Radio Access Network (RAN) server or any other information handling system relevant to embodiments herein.

In a networked deployment, the information handling system 100 may operate in the capacity of a server or as a client computer in a server-client network environment, or as a peer computer system in a peer-to-peer (or distributed) network environment. In a particular embodiment, the information handling system 100 may be implemented using electronic devices that provide voice, video or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or multiple sets, of instructions to perform one or more computer functions.

In an embodiment, the information handling system 100 may operate as a cloud-based management server and include an enterprise endpoint eSIM provisioning system 132 that may be any device or devices that execute instructions, parameter, and profiles 124 so that voice and data communication requests from endpoint computing device(s) may be received and routed to a WWAN communication network 128, as described herein. The execution of the enterprise endpoint eSIM provisioning system 132 may optimally manage the assignment, revocation, and reassignment of a plurality of eSIM profiles (e.g., international mobile subscriber identity (IMSI) and mobile station international subscriber directory number (MSISDN)) purchased by an enterprise from a plurality of mobile broadband network or RAN providers (e.g., SPRINT®, Verizon®, T-Mobile®, AT&T®, etc.) to a plurality of enterprise endpoint devices owned and managed by the enterprise. The information handling system 100 may operate in relevant parts as an endpoint device as well.

The information handling system 100 may include a memory 104, (volatile (e.g. random-access memory, etc.), nonvolatile memory (read-only memory, flash memory etc.) or any combination thereof), one or more processing resources, such as a central processing unit (CPU), a graphics processing unit (GPU), either of which may be the processor 102 illustrated in FIG. 1, hardware or software control logic, or any combination thereof. Additional components of the information handling system 100 may include one or more storage devices 106 or 116, the network interface device 120, one or more communications ports for communicating with external devices, as well as, various input and output (I/O) devices 112, such as a keyboard, a mouse, or any combination thereof. The information handling system 100 may further include a video display 110. The video display 110 in an embodiment may function as a liquid crystal display (LCD), an organic light emitting diode (OLED), a flat panel display, or a solid-state display. The information handling system 100 may also include one or more buses (e.g., 108) operable to transmit communications between the various hardware components. Portions of an information handling system 100 may themselves be considered information handling systems 100 in the embodiments presented herein.

Information handling system 100 may include devices or modules that embody one or more of the devices or execute instructions for the one or more systems and modules described herein, and operates to perform one or more of the methods described herein. The information handling system 100 may execute code instructions 124 that may operate on servers or systems, remote data centers, or on-box in individual client information handling systems 100 according to various embodiments herein. In some embodiments, it is understood any or all portions of code instructions 124 may operate on a plurality of information handling systems 100.

The information handling system 100 may include a processor 102 such as a central processing unit (CPU), a GPU, or control logic or some combination of the same. Any of the processing resources may operate to execute code that is either firmware or software code. Moreover, the information handling system 100 may include memory such as main memory 104, static memory 106, containing computer readable medium 122 storing instructions 124. Instructions 124 may include an enterprise endpoint eSIM provisioning system 132, operating system (OS) software, application software, BIOS software, or other software applications or drivers detectable by processor type 102. For example, the enterprise endpoint eSIM provisioning system 132 in an embodiment may operate, at least in part, as a virtual driver within an enterprise endpoint device enabling storage in kernel mode of identifying information for the enterprise endpoint device received via an authenticated BIOS interface. As another example, the enterprise endpoint eSIM provisioning system 132 in an embodiment may operate, at least in part, as an application executable via the operating system of an information handling system, such as management servers of an ECM system located remotely from the enterprise endpoint device.

The disk drive unit 116 and static memory 106 may also contain space for data storage. The instructions 124 in an embodiment may reside completely, or at least partially, within the main memory 104, the static memory 106, and/or within the disk drive 116 during execution by the processor 102. The information handling system 100 may also include one or more buses 108 operable to transmit communications between the various hardware components such as any combination of various input and output (I/O) devices, display 110, network interface device 120, or the like.

The network interface device 120 may provide connectivity of the information handling system 100 to one or more endpoint computing devices. In another aspect of an embodiment, the network interface device 120 may also provide connectivity of the information handling system 100 to communication network 128. For example, communication network 128 in an embodiment may comprise a cellular, wireless wide area network (WWAN) communication network capable of transceiving data in compliance with the 5G cellular network standard. In another example, communication network 128 in an embodiment may comprise a wireless local area network (WLAN) communication network capable of transceiving data in compliance with current Wi-Fi standards (e.g., IEEE 802.11). In other embodiments, the communication network 128 may comprise a wired local area network (LAN), a wireless personal area network (WPAN), a public WiFi communication network, a private WiFi communication network, a public WiMAX communication network, or other non-cellular communication networks. In some aspects of the present disclosure, the network interface device 120 may operate two or more wireless links. For example, a boot-strap wireless link between an enterprise endpoint device and the enterprise endpoint eSIM provisioning system 132 operating as a management server of an ECM system may occur via wired local area network (LAN), or wireless local area network (WLAN), such as Wi-Fi. Such a boot-strap wireless link may be established via out-of-band communications using an authenticated BIOS interface to a virtual driver of the enterprise endpoint device operating in kernel mode. In other aspects of the present disclosure, the information handling system 100 may include a plurality of network interface devices (e.g., WWAN and wireless local area network (WLAN) network interface devices), each operating separate radio subsystems.

The network interface device 120 may operate in accordance with any cellular wireless data communication standards. Network interface device 120, in an embodiment, may connect to any combination of macro-cellular wireless connections including 2G, 2.5G, 3G, 4G, 5G or the like from one or more service providers. Utilization of radiofrequency communication bands according to several example embodiments of the present disclosure may include bands used with the WWAN standards, which may operate in both licensed and unlicensed spectrums. More specifically, the network interface device 120 in an embodiment may transceive within radio frequencies associated with the 5G New Radio (NR) Frequency Range 1 (FR1) or Frequency Range 2 (FR2). NRFR1 may include radio frequencies below 6 GHz, associated with 4G LTE and other standards predating the 5G communications standards now emerging. NRFR2 may include radio frequencies above 6 GHz, made available within the now emerging 5G communications standard. Communications within NRFR1 may be enabled through the use of either an evolved Node B (eNodeB) executing an evolved packet core of an existing LTE system, or a Next Generation Node B (gNodeB) executing the next generation packet core of the 5G cellular standard.

Frequencies related to the 5G networks may include high frequency (HF) band, very high frequency (VHF) band, ultra-high frequency (VHF) band, L band, S band, C band, X band, Ku band, K band, Ka band, V band, W band, and millimeter wave bands. WWAN may use the Unlicensed National Information Infrastructure (U-NII) band which typically operates in the ˜5 GHz frequency band such as 802.11 a/h/j/n/ac (e.g., center frequencies between 5.170-5.785 GHz). It is understood that any number of available channels may be available under the 5 GHz shared communication frequency band. WWAN may operate in a number of bands, some of which are proprietary but may include a wireless communication frequency band at approximately 2.5 GHz band for example. In additional examples, WWAN carrier bands may operate at frequency bands of approximately 700 MHz, 800 MHz, 1900 MHz, or 1700/2100 MHz for example as well.

To communicate with a wireless local area network (WLAN), standards including IEEE 802.11 WLAN standards, IEEE 802.15 WPAN standards, WiMAX, or similar wireless standards may be used. Utilization of radiofrequency communication bands according to several example embodiments of the present disclosure may include bands used with the WLAN standards which may operate in both licensed and unlicensed spectrums. For example, WLAN may use the Unlicensed National Information Infrastructure (U-NII) band which typically operates in the ˜5 MHz frequency band such as 802.11 a/h/j/n/ac (e.g., center frequencies between 5.170-5.785 GHz). It is understood that any number of available channels may be available under the 5 GHz shared communication frequency band. WLAN, for example, may also operate at a 2.4 GHz band, or a 60 GHz band.

The network interface device 120 in an embodiment may further include an antenna front end system 125 which may operate to modulate and demodulate signals transceived within various formats (e.g., WWAN, WLAN, WPAN, etc.) via the antenna system 136, set signal transmission power levels or sensitivity to signal reception, select channels or frequency bands, and conduct other functions in support of a wireless transmission to the communication network 128. The antenna adaptation controller 134 may execute instructions for monitoring wireless link state information, endpoint configuration data (e.g., including eSIM profiles used to initiate such wireless links), network slice data, or other input data to generate channel estimation and determine antenna radiation patterns.

In some embodiments, software, firmware, dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a controller or a processor system. Further, in an exemplary, non-limited embodiment, implementations may include distributed processing, component/object distributed processing, and parallel processing. Alternatively, virtual computer system processing may be constructed to implement one or more of the methods or functionalities as described herein.

The present disclosure contemplates a computer-readable medium that includes instructions, parameters, and profiles 124 or receives and executes instructions, parameters, and profiles 124 responsive to a propagated signal, so that a device connected to a network 128 may communicate voice, video or data over the network 128. Further, the instructions 124 may be transmitted or received over the network 128 via the network interface device 120. The information handling system 100 may include a set of instructions 124 that may be executed to cause the computer system to perform any one or more of the methods or computer-based functions disclosed herein. For example, instructions 124 may execute an enterprise endpoint eSIM provisioning system 132, or other aspects or components. Various software modules comprising application instructions 124 may be coordinated by an operating system (OS), and/or via an application programming interface (API). An example operating system may include Windows®, Android®, and other OS types. Example APIs may include Win 32, Core Java API, or Android APIs. Application instructions 124 may also include any application processing drivers, or the like executing on information handling system 100 as an endpoint device managed by or as an enterprise endpoint eSIM provisioning system.

The enterprise endpoint eSIM provisioning system 132 may utilize a computer-readable medium 122 in which one or more sets of instructions 124 such as software may be embedded. The instructions 124 may embody one or more of the methods or logic as described herein. For example, instructions relating to the enterprise endpoint eSIM provisioning system 132, software algorithms, processes, and/or methods may be stored here. As explained, some or all of the enterprise endpoint eSIM provisioning system 132 may be executed locally or remotely.

Main memory 104 may contain computer-readable medium (not shown), such as RAM in an example embodiment. An example of main memory 104 includes random access memory (RAM) such as static RAM (SRAM), dynamic RAM (DRAM), non-volatile RAM (NV-RAM), or the like, read only memory (ROM), another type of memory, or a combination thereof. Static memory 106 may contain computer-readable medium (not shown), such as NOR or NAND flash memory in some example embodiments. The instructions, parameters, and profiles 124 of the enterprise endpoint eSIM provisioning system 132 may be stored in static memory 106, or the drive unit 116 on a computer-readable medium 122 such as a flash memory or magnetic disk in an example embodiment. While the computer-readable medium is shown to be a single medium, the term “computer-readable medium” includes a single-medium or multiple-media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to store information received via carrier wave signals such as a signal communicated over a transmission medium. Furthermore, a computer readable medium may store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The information handling system 100 may also include the enterprise endpoint eSIM provisioning system 132 that may be operably connected to the bus 108. The enterprise endpoint eSIM provisioning system 132 may, according to the present description, perform tasks related to managing distribution of a plurality of eSIM profiles among a plurality of enterprise endpoint devices, and enterprise endpoint devices using these received eSIM profiles to access a WWAN network (e.g., 128). In an embodiment, the enterprise endpoint eSIM provisioning system 132 may communicate with the main memory 104, the processor 102, the video display 110, the input device 112, and the network interface device 120, via bus 108, and several forms of communication may be used, including ACPI, SMBus, a 24 MHZ BFSK-coded transmission channel, or shared memory. Driver software, firmware, controllers and the like may communicate with applications on the information handling system 100, and various hardware systems.

In some embodiments, dedicated hardware implementations such as application specific integrated circuits, programmable logic arrays and other hardware devices may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

When referred to as a “system”, a “device,” a “module,” a “controller,” or the like, the embodiments described herein may be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module may include software, including firmware embedded at a device, such as an Intel® Core or Xeon class processor, ARM® brand processors, Qualcomm® processors, or other processors and chipsets, or other such device, or software capable of operating a relevant environment of the information handling system. The system, device, controller, or module may also include a combination of the foregoing examples of hardware or software. In an embodiment an information handling system 100 may include an integrated circuit or a board-level product having portions thereof that may also be any combination of hardware and software. Devices, modules, resources, controllers, or programs that are in communication with one another need not be in continuous communication with each other, unless expressly specified otherwise. In addition, devices, modules, resources, controllers, or programs that are in communication with one another may communicate directly or indirectly through one or more intermediaries.

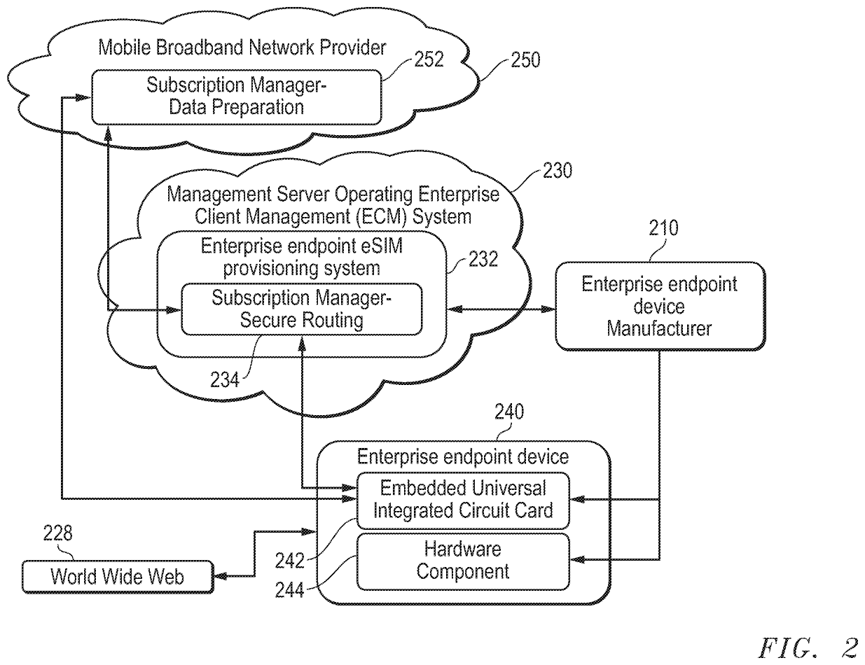

FIG. 2 is a block diagram illustrating an enterprise endpoint eSIM provisioning system 232 operating at a management server of an enterprise client management (ECM) system to provision eSIM profiles purchased from a Radio Access Network (RAN) to an enterprise endpoint device 240 according to an embodiment of the present disclosure. As described herein, the emerging 5G standard support for remote delivery of eSIM profiles from ECM system 230 (e.g., a cloud client management (CCM) platform) to an enterprise endpoint device 240 presents an opportunity to optimize use of eSIM profiles across a plurality of enterprise endpoint devices (e.g., including 240). The enterprise endpoint eSIM provisioning system 232 in an embodiment may operate, at least partially, in tandem with or as part of an ECM system 230 to enable such optimization. In an embodiment, the enterprise owner of a plurality of enterprise endpoint devices (e.g., including 240) may operate the enterprise endpoint eSIM provisioning system 232 of the ECM system at a management server 230, to manage assignment and delivery of a pool of eSIM profiles, purchased by the enterprise from a mobile broadband network or RAN 250, to the plurality of enterprise endpoint devices (e.g., including 240).

The enterprise endpoint device 240 in an embodiment may be manufactured at an enterprise endpoint device manufacturer 210. This process may entail compilation of a plurality of hardware modules incorporated within an information handling system to create the enterprise endpoint device 240. For example, such hardware modules in an embodiment may include an embedded universal integrated circuit card (eUICC) 242, a processor, a main or static memory, a drive unit, a power unit, and various buses, bridges, or ports, among other components, cards, integrated circuits, and the like. Each eUICC 242 placed into an enterprise endpoint device 240 in such a way may be associated with a unique identification applied by the eUICC manufacturer, called an eUICC information set. The enterprise endpoint device manufacturer 210 in an embodiment may transmit a hardware derived device ID unique to one or more additional hardware components (e.g., 244) of the enterprise endpoint device 240 or the eUICC information set unique to the eUICC 242 to the management server of the ECM system 230 in order to identify itself when requesting access to an eSIM profile.

Each of the other hardware components may be associated with a serial number or other identifying code. The enterprise endpoint device manufacturer 210 in an embodiment may generate a hardware derived device ID unique to the device based on a combination of serial numbers (or other identifying information) from one or more of these hardware components. The eUICC 242 may also have an identification given within an eUICC information set. The eUICC information set may also form a portion of the encrypted unique hardware derived device IDentification in some embodiments. For example, the enterprise endpoint device manufacturer 210 in an embodiment may combine or apply a hash algorithm to serial numbers from one or more hardware components installed within the enterprise endpoint device 240. In another embodiment, the hardware derived device ID may further be encrypted using a shared private key stored at the enterprise endpoint device 240 and at the management servers operating the ECM system 230. In still other embodiments, the hardware derived device ID may be further based on serial numbers for one or more software applications loaded onto the enterprise endpoint device 240 by the ECM system 230, and tracked by the ECM system 230.

As described herein, when requesting an eSIM profile from the enterprise endpoint eSIM provisioning system 232 operating at management servers for the ECM system 230, the enterprise endpoint device 240 may provide information or credentials that the ECM system 230 may use to identify the enterprise endpoint device 240. In some embodiments, the unique hardware derived device ID, generated based on serial numbers for one or more hardware components 244 of the enterprise endpoint device 240 may be used to identify the enterprise endpoint device 240 at the ECM system 230. In another embodiment, the eUICC information set unique to the eUICC 242 may be used to identify the enterprise endpoint device 240. In still other embodiments, both the eUICC information set and the unique hardware derived device ID may be used to identify the enterprise endpoint device 240 to the ECM system 230.

The enterprise endpoint eSIM provisioning system 232 in an embodiment may store each of these identifiers (e.g., eUICC information set and hardware derived device ID) and an association between them. In an embodiment in which the enterprise endpoint device has identified itself to the ECM system 230 using the unique hardware derived device ID, rather than the eUICC information set, the ECM system 230 may use this association between the unique hardware derived device ID and the eUICC information set in order to determine which eUICC (e.g., 242) is incorporated within the enterprise endpoint device 240. The ECM system 230 may provide this eUICC identification to the mobile broadband network provider 250 in an embodiment in order to receive an eSIM profile managed by the mobile broadband network provider 250. In other words, the ECM system 230 may retrieve the eUICC information set required for transmission to the mobile broadband network provider 250 from the stored association between the unique hardware derived device ID and the eUICC 242, even if the enterprise endpoint device 240 transmits the unique hardware derived device ID to the ECM system 230 to identify itself, rather than the eUICC information set associated with eUICC 242.

This association in some embodiments may be accessed later to ensure that an enterprise endpoint device 240 requesting delivery of eSIM profiles undergoes multi-level security check by providing both the eUICC information set unique to the eUICC 242 and the hardware derived device ID generated based on a serial number for one or more hardware components, as associated with one another at the enterprise endpoint eSIM provisioning system 232. The hardware derived device ID in an embodiment may be generated at the enterprise endpoint device 240 as harvested by the manufacturer 210, and may be stored at the enterprise endpoint eSIM provisioning system 232, and the manufacturer 210. These identifiers may not be shared outside the enterprise system (e.g., in communication with the mobile broadband network or RAN 250).

In some embodiments, the enterprise endpoint device 240 may generate the hardware derived device ID itself, based on instructions stored in firmware of one or more hardware components (e.g., 244) of the enterprise endpoint device 240. Such instructions may direct the hardware component (e.g., 244) to access the serial numbers for the one or more hardware components forming the basis of the hardware derived device ID via a virtual driver in kernel mode, and to combine, hash, or encrypt these serial numbers according to a preset algorithm or method, also known by the ECM system 230. In such an embodiment, the enterprise endpoint device 240 may be capable of generating an updated hardware derived device ID when any of the hardware components whose serial numbers form the basis of the hardware derived device ID are replaced with other hardware components via authorization of changes to the stored hardware derived device ID at ECM system 230. The ECM system 230 in such an embodiment may thus track the authorized replacement of such hardware components for each managed endpoint device 240. Thus, the ECM system 230 may also use the same preset algorithm method to generate an updated hardware derived device ID for the enterprise endpoint device 240. However, if a hardware component is replaced without oversight from an enterprise administrator, or without updating the hardware components assigned to the enterprise endpoint device 240 as identified at the ECM system 230, the updated hardware derived device ID generated by the enterprise endpoint device 240 and the updated hardware derived device ID generated at the ECM system 230 may not match, prompting the ECM system 230 to deny the enterprise endpoint device 240 access to requested eSIM profiles.

The enterprise endpoint eSIM provisioning system 232 in an embodiment may be located within management servers of an ECM system 230. In other embodiments, the enterprise endpoint eSIM provisioning system 232 may be located remotely from the management servers of the ECM system 230 and the enterprise endpoint device 240, but may work in tandem with the management servers of the ECM system 230 as a cloud-based eSIM management system for provisioning eSIMs to plural, managed enterprise endpoint devices. In an example embodiment, the ECM system 230 may include management servers of a cloud client management (CCM) platform. In other embodiments, the ECM system 230 may incorporate an enterprise mobility management platform (e.g., VMware® AirWatch®), a cloud-based management solution (e.g., Microsoft Endpoint Manager®), a unified endpoint and enterprise mobility management platform (e.g., MobileIron®), a mobile device management solution (e.g., Citrix® Zenprise® or a clients managing software suite (e.g., Dell® Wyse Management Suite®). In still other embodiments, the ECM system 230 may incorporate various attributes from a combination of these platform types.

In an embodiment, the management servers of the ECM system 230 may operate to manage various credentials (e.g., user passwords, login information, user accounts, eSIM profiles), and monitor a plurality of operation conditions at the enterprise endpoint device 240, as well as a plurality of other enterprise endpoint devices. These enterprise endpoint devices (e.g., including 240 and a plurality of others) may comprise various types of information handling systems capable of communication via a WWAN cellular network, such as laptops, notebooks, tablets, smart phones, cellular phones, IoT devices, servers, blades, printers, faxes, smart cars, navigation systems, etc.

The ECM system 230 in an embodiment may track which profiles have been assigned to which endpoint devices (e.g., including 240), and routinely gather operation conditions from these endpoint devices (e.g., including 240) as well as ensuring maintenance of security measures and gathering performance metrics at each of these enterprise endpoint devices (e.g., including 240). Enterprise endpoint device 240 may check-in with the ECM system management servers 230 in an embodiment, with check-in data including hardware derived device IDentification and reports of operation conditions or anticipated operation conditions for enterprise endpoint device 240. These operation conditions or anticipated operation conditions may be used to determine a type of wireless RAN or wireless service level to be assigned to an endpoint device. The levels of wireless service in an embodiment may be defined by setting one or more minimum requirements for wireless link quality. For example, a level of wireless service in an embodiment may identify a throughput requirement as a minimum requirement. In other embodiments, requirements associated with another connectivity parameter within a level of wireless service, such as a quality of service (QoS) rating, a number of dropped packets, or latency may be identified as a minimum requirement. In still other embodiments, requirements associated with a plurality of connectivity parameters may be identified as minimum requirements, such that each of these requirements must be met in order to conform to the level of wireless service. In yet another embodiment, the priority of these requirements associated with a plurality of connectivity parameters may be weighted in some fashion.

Operation conditions in an embodiment may include, for example, the geographic or physical location of the enterprise endpoint device 240, or an identification of the user currently logged into the enterprise endpoint device 240 (or anticipated to be logged on before the next scheduled check-in). In another example, operation conditions transmitted from the enterprise endpoint device 240 to the ECM system 230 may include identification of applications either currently running or whose execution is imminently anticipated. In some embodiments, some applications may be scheduled to execute according to preset timetables, and these preset timetables or schedules may be transmitted to the ECM system 230.

The performance metrics gathered by the ECM system 230 in an embodiment may also include wireless link state information and endpoint configuration data (e.g., including eSIM profiles used to establish wireless links), as gathered by the antenna adaptation controller of FIG. 1, for example. The ECM system 230 in an embodiment may store this wireless link state information, as well as eSIM profiles used to establish such wireless links, as well as geographic locations of enterprise endpoint devices (e.g., 240) at the time such data is gathered. The enterprise may gather such information from a plurality of enterprise endpoint devices (e.g., 240), some of which may be in transit, dispersed across large geographic areas, and communicating via a plurality of mobile broadband networks or RANs (e.g., 250). Analysis of a compilation of data gathered from each of the plurality of enterprise endpoint devices may thus provide a high-level estimate of wireless link quality in a given location, established via a specific mobile broadband network or RAN (e.g., 250). When any one of these operation conditions changes between such periodic wireless check-ins (e.g., due to a change in location, a change in users, or a change in one or more applications being executed), the enterprise endpoint device 240 may transmit an updated operation condition describing these changes during the next period wireless check-in.

These routine check-ins may be performed using out-of-band communications in some embodiments. For example, in some embodiments, the routine check-in may occur via a boot-strap, alternative wireless network such as Wi-Fi, or via wired connection. Managed endpoint device check-ins may be required periodically or when a boot-strap connection is available at the enterprise endpoint device 240. Such a check-in may cause a change in an allocated eSIM profile.

The enterprise endpoint eSIM provisioning system 232 in an embodiment may operate to retrieve an eSIM profile from a mobile broadband network or RAN provider (e.g., 250) operating a RAN. That profile may be assigned to an enterprise endpoint device (e.g., 240). The enterprise endpoint eSIM provisioning system 232 in such an embodiment may include a secure routing subscription manager 234, which may begin this process by transmitting a request to the mobile broadband network or RAN 250 for an eSIM profile purchased by the enterprise. As part of this request, the secure routing subscription manager 234 may include the eUICC information set unique to the eUICC 242 of a single enterprise endpoint device 240. The data preparation subscription manager 252 operating at the mobile broadband network or RAN 250 in an embodiment may respond by generating an eSIM profile including the eUICC information set received from the secure routing subscription manager 234, an International Mobile Subscriber Identification (IMSI), a mobile station international subscriber directory number (MSISDN), and various connectivity parameters for establishing a wireless link between the enterprise endpoint device 240 and the world wide web 220 via the mobile broadband network or RAN 250. The eSIM profile so generated may also include, for example, an element of a file system such as a master file, an elementary file, or a dedicated file, containing at least in part, an eSIM profile, and information used to establish a secure channel between the enterprise endpoint device 240 and the data preparation subscription manager 252.

By generating such an eSIM profile in an embodiment, the mobile broadband network or RAN 250 may assign the IMSI and MSISDN within the profile to the individual eUICC 242 identified within the eUICC information set transmitted by the secure routing subscription manager 234. The eSIM profile may not initially be enabled, and may not be enabled until the enterprise endpoint device 240 establishes a secure channel with the mobile broadband network or RAN 250 and provides information needed to positively identify the endpoint device 240 as the device to which the eSIM credentials (e.g., IMSI and MSISDN) given within the profile have been assigned. The data preparation subscription manager 252 in an embodiment may transmit this not-yet-enabled eSIM profile to the secure routing subscription manager 234 for delivery to the enterprise endpoint device 240.

The secure routing subscription manager 234 in an embodiment may receive a request from the enterprise endpoint computing device 240 for assignment of an eSIM profile. As part of this request, the enterprise endpoint computing device 240 may also transmit some form of identification of the enterprise endpoint computing device 240 to the secure routing subscription manager 234. As described herein, the enterprise endpoint computing device 240 in an embodiment may transmit to the secure routing subscription manager 234, for example, the unique hardware derived device ID generated based on serial numbers or other identifying information of one or more hardware components 244 incorporated within the enterprise endpoint device 240. In another embodiment, the enterprise endpoint computing device 240 may transmit to the secure routing subscription manager 234 the eUICC information set unique to the eUICC 242 as a form of identification for the enterprise endpoint device 240. In still other embodiments, the enterprise endpoint device 240 may transmit to the secure routing subscription manager 234 both the unique hardware derived device ID and the eUICC information set. In such an embodiment, the enterprise endpoint eSIM provisioning system 232 in an embodiment may check to ensure that the received eUICC information set unique to the eUICC 242 and the hardware derived device ID are associated with one another in storage at the ECM system 230 before transmitting the requested eSIM profile to the enterprise endpoint device 240.

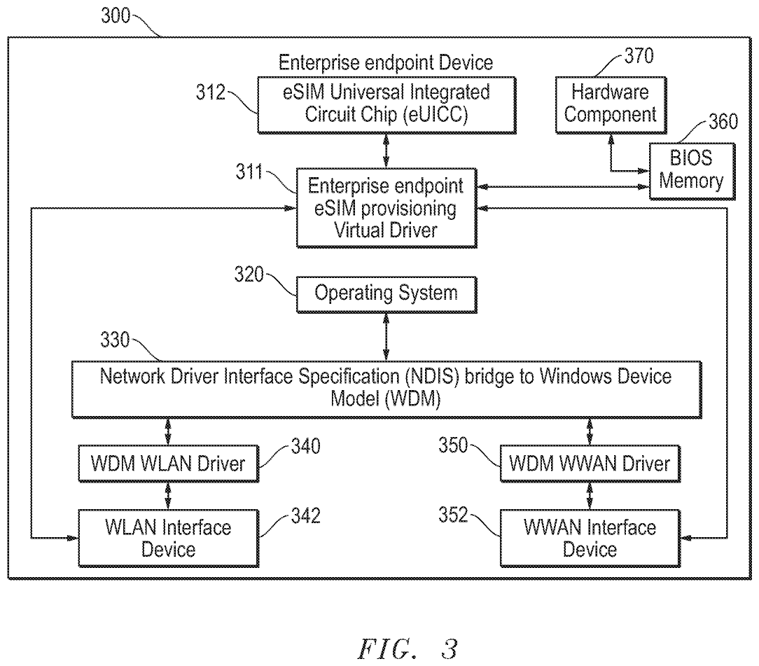

Upon successful identification of the enterprise endpoint device 240 via the eUICC information set unique to the eUICC 242 or the hardware derived device ID in an embodiment, the secure routing subscription manager 234 may transmit the eSIM profile, or portions thereof, including at least the IMSI, MSISDN, and information used to establish the secure channel with the mobile broadband network or RAN 250 to the enterprise endpoint device 240. This transmission may occur via boot-strap wireless network connection (e.g., via a WLAN wireless link, or a wired connection) using an authenticated BIOS interface while the enterprise endpoint device 240 is operating in kernel mode, as described in greater detail with respect to FIG. 3. The enterprise endpoint eSIM provisioning system 232 may use the same authenticated BIOS interface to instruct or cause the deletion of the eSIM profile in an embodiment in which the eSIM profile is enabled and later disabled or deleted (e.g., for failure to make required payments, or due to reassignment of the profile to another endpoint device by the enterprise endpoint eSIM provisioning system 232) by the mobile broadband network or RAN 250. The enterprise endpoint device 240 in an embodiment may store the received eSIM profile, or portions thereof, in a BIOS memory location accessible only in kernel mode. For example, the eSIM profile may be flashed to a secure memory in firmware of the WWAN module of the enterprise endpoint device.

The enterprise endpoint device 240 in an embodiment may establish a secure channel with the data preparation subscription manager 252 of the mobile broadband network or RAN 250 using the information stored within the eSIM profile delivered to the enterprise endpoint device 240 by the secure routing subscription manager 234. The enterprise endpoint device 240 may also provide the IMSI or MSISDN from the eSIM profile, as well as the eUICC information set unique to the eUICC 242, and a request to enable the eSIM profile. The data preparation subscription manager 252 may authenticate the enterprise endpoint device 240, including at least a determination that the eUICC information set unique to the eUICC 242 received from the enterprise endpoint device 240 matches the eUICC information set stored within the eSIM profile at the data preparation subscription manager 252. Once the enterprise endpoint device 240 has been authenticated, the data preparation subscription manager 252 may enable the eSIM profile transmitted from the data preparation subscription manager 252 to the enterprise endpoint device 240 via the enterprise endpoint eSIM provisioning system 232. At this point, the IMSI or MSISDN within the eSIM profile associated with the enterprise endpoint device 240 may be activated, such that the enterprise endpoint device 240 may use the credentials (e.g., IMSI or MSISDN) within the enabled eSIM profile to operate via the mobile broadband network or RAN to access the world wide web 228. The data preparation subscription manager 232 in an embodiment may transmit an update to the enterprise endpoint eSIM provisioning system 232 and the enterprise endpoint device 240 indicating that the eSIM profile associated with the enterprise endpoint device 240 has been enabled.

Should the enterprise fail to make minimum payments to the mobile broadband network or RAN operator, the data preparation subscription manager 252 may later disable the eSIM profile and transmit notification of such to the secure routing subscription manager 234 in an embodiment. Similarly, should the enterprise endpoint eSIM provisioning system 232 reassign the eSIM profile to another enterprise endpoint device in an embodiment, the secure routing subscription manager 234 may transmit a notification of such a reassignment, and the data preparation subscription manager 252 may accordingly disable the eSIM profile with respect to the enterprise endpoint device 240. The data preparation subscription manager 252 may then generate a new eSIM profile associating the IMSI or MSISDN previously enabled with respect to enterprise endpoint device 240 with the reassigned enterprise endpoint device, and transmit the new eSIM profile to the enterprise endpoint eSIM provisioning system for delivery to the reassigned endpoint device.

In some embodiments, the enterprise endpoint eSIM provisioning system 232 may work in tandem with the management servers at the ECM system 230 to optimize use of each of the eSIM profiles within the pool of profiles purchased from the mobile broadband network or RAN 250, and other pools of profiles purchased from plural mobile broadband networks or RANs. The enterprise endpoint eSIM provisioning system 232 in an embodiment may assign eSIM profiles to enterprise endpoint devices (e.g., 240) based, at least in part, on the operation conditions gathered from each of the plurality of enterprise endpoint devices managed by the ECM system 230. For example, the assignment of a given eSIM profile to a given enterprise endpoint device (e.g., 240) in an embodiment may be made based on the geographic location of the enterprise endpoint device, an identification of the user logged into the enterprise endpoint device, or upon software applications running at the enterprise endpoint device, as described in the check-in data reported to the ECM system 230 during required periodic wireless check-ins. In some embodiments, the assignment of an eSIM profile to the enterprise endpoint device 240 may be made based on anticipated changes in any one of these conditions, as indicated based on scheduled application events given in check-in data, or based on patterns detected in previously received check-in data (e.g., routine switching of users or geographic locations).

Each of these operation conditions, or combinations of these operation conditions may be associated with minimum levels of wireless service. For example, some users (e.g., enterprise corporate officers, test engineers, sales representatives frequently performing demonstrations of robust software for clients) may be associated with higher levels of wireless service than others. As another example, certain applications may require more reliable, or faster wireless signals in order to successfully execute, causing some applications to be associated with higher levels of wireless service than others. As yet another example, some geographic locations may receive stronger signals than others, causing the minimum level of wireless service associated with geographic locations receiving weaker signals to be lower than the minimum level of wireless service associated with geographic locations receiving stronger signals.

In some scenarios, the enterprise endpoint eSIM provisioning system 232 in an embodiment may provision a plurality of eSIM profiles to a single enterprise endpoint device (e.g., 240). For example, enterprise endpoint device 240 may be mobile and need to access a plurality of mobile broadband networks or RANs during travel, such that a signal meeting minimum service level requirements can always be accessed. In such an example embodiment, the enterprise endpoint eSIM provisioning system 232 may issue a plurality of eSIM profiles to the enterprise endpoint device 240, with each of the plurality of eSIM profiles granting the enterprise endpoint device 240 access to a separate mobile broad band network (e.g., including 250 and other mobile broadband networks or RANs managed or owned by other operators).

In another example embodiment, the enterprise endpoint device 240 may only require access to a single mobile broadband network or RAN (e.g., 250), because that is the only network available at the current location for the enterprise endpoint device 240, and capable of meeting the minimum level of wireless service associated with the enterprise endpoint device 240 (or its operation conditions) at the ECM system 230. In such an example embodiment, the enterprise endpoint eSIM provisioning system 232 may assign the one eSIM profile to the enterprise endpoint device 240 for the available mobile broadband network or RAN.

In still another example, the enterprise endpoint device 240 may routinely travel between two geographic locations, each receiving a strongest signal from a separate mobile broadband network or RAN provider (e.g., 250). More specifically, an employee in possession of the enterprise endpoint device 240 may routinely travel, on a known schedule, from a first office, where AT&T® has the best coverage, to a second office, where Verizon® has the best coverage. In such an example embodiment, the enterprise endpoint eSIM provisioning system 232 may operate to assign and transmit to the enterprise endpoint device 240 an eSIM profile from the pool of profiles purchased from mobile broadband network or RAN 250 which may be owned and operated by AT&T®, just prior to the scheduled travel to the first office (or upon request by the employee just prior to her travel to the first office). Upon the employee's departure from the first office to the second office, the enterprise endpoint eSIM provisioning system 232 in such an embodiment may revoke the AT&T® eSIM profile assigned to the enterprise endpoint device 240, and assign and transmit to the enterprise endpoint device 240 an eSIM profile from the pool of profiles purchased from Verizon®. This additionally allows the enterprise endpoint eSIM provisioning system 232 to reassign the revoked AT&T® eSIM profile to another enterprise endpoint device currently exhibiting a greater need for access to the AT&T® network 250. In such a way, the enterprise endpoint eSIM provisioning system 232 may distribute the plurality of eSIM profiles from a plurality of network providers across an ecosystem of enterprise endpoint devices (e.g., 240) owned by a single enterprise in a cost-effective manner, based on current needs of each of the enterprise endpoint devices (e.g., 240).

The ECM system 230 in an embodiment may identify one or more mobile broadband networks or RANs (e.g., 250) exhibiting network connectivity performance (e.g., as determined in reference to the high-level estimation of connectivity metrics generated at the ECM system 230 based on check-in data describing operation conditions retrieved across the plurality of enterprise endpoint devices) at the geographic location of the enterprise endpoint device 240 that meet the minimum requirement(s) associated with the enterprise endpoint device 240. Multiple protocols such as 3G, 4G, 5G NR1, 5G NR2, or others may be among the pool of available eSIM profile to be provisioned to the enterprise endpoint device 240 in some embodiments. These may be purchased by an enterprise from plural service providers. The ECM system 230 in such an embodiment may notify the enterprise endpoint eSIM provisioning system of these identified one or more mobile broadband networks or RANs (e.g., 250). In some embodiments, the ECM system 230 may rank these mobile broadband networks or RANs based on estimated connectivity metrics for each.

The enterprise endpoint eSIM provisioning system 232 may instruct the secure routing subscription manager 234 to initiate a request for an eSIM profile from one or more of these mobile broadband networks or RANs identified by the ECM system 230, based on such a ranked list of networks, or upon availability of an eSIM profile for a given mobile broadband network or RAN (e.g., 250) from the pool of eSIM profiles purchased by the enterprise. In other words, if the ECM system 230 identifies two mobile broadband networks or RANs capable of meeting the minimum level of wireless service for the enterprise endpoint device 240, the enterprise endpoint eSIM provisioning system 232 may determine all eSIM profiles purchased from one of these two mobile broadband networks or RANs have already been assigned to other enterprise endpoint devices. In such a scenario, the enterprise endpoint eSIM provisioning system 232 may instruct the secure routing subscription manager 234 to request an eSIM profile from the other of these two mobile broadband networks or RANs that manages eSIM profiles purchased by the enterprise but not yet assigned to other enterprise endpoint devices. In such a way, the enterprise endpoint eSIM provisioning system 232 may work in tandem with the ECM system 230 to optimally distribute eSIM profiles from a plurality of mobile broadband networks or RANs (e.g., 250) across a plurality of enterprise endpoint devices (e.g., 240) in a cost effective manner that satisfies minimum level of wireless service for the plurality of enterprise endpoint devices.

FIG. 3 is a block diagram illustrating an enterprise endpoint device 300 operating an enterprise endpoint eSIM provisioning system virtual driver 311 to establish an authenticated BIOS interface with a remotely located enterprise client management (ECM) system according to an embodiment of the present disclosure. As described herein, the enterprise endpoint device 300 in an embodiment may request assignment of an eSIM profile by a remotely located enterprise endpoint eSIM provisioning system located at or working in tandem with management servers of a remote ECM system (e.g., cloud client management (CCM) platform), via a boot-strap or alternative wireless network connection to a mobile broadband network for which access is being requested. For example, an out-of-band communication by the authenticated BIOS interface may occur via the WLAN interface device 342 in some embodiments. Upon proper authentication of the enterprise endpoint device 300 by the enterprise endpoint eSIM provisioning system in an embodiment, the enterprise endpoint eSIM provisioning system may transmit the requested eSIM profile to enable the enterprise endpoint device 300 to establish a secure channel with the mobile broadband network or RAN that generated the eSIM profile. The mobile broadband network or RAN operator may authenticate the enterprise endpoint device 300 via this secure channel, and enable the eSIM profile stored at the enterprise endpoint device 300 such that the enterprise endpoint device 300 is capable of communicating with the world wide web via the mobile broadband network or RAN.

The enterprise endpoint device 300 in an embodiment may include an embedded universal integrated circuit chip (eUICC) 312, an enterprise endpoint eSIM provisioning virtual driver 311, a BIOS memory 360, one or more hardware component 370 (such as shown or described with reference to FIG. 2), an operating system 320, a network driver interface specification (NDIS) bridge to a windows device model (WDM), one or more network drivers (e.g., WLAN driver 340 or WWAN driver 350), and one or more network interface devices (e.g., WLAN interface device 342 or WWAN interface device 352).

A manufacturer of the enterprise endpoint device 300 may couple these internal components together to form the enterprise endpoint device 300. Upon manufacture of the enterprise endpoint device 300 by operatively coupling the various hardware components (e.g., including 370 and eUICC 312), the manufacturer store the eUICC identifier specific to the eUICC 312 and a serial number or other identifying code for hardware component 370 in the BIOS memory 360.

As described herein, one or more hardware components 370 may be associated with a serial number or other identifying code. The manufacturer of the enterprise endpoint device 300 in an embodiment may generate a hardware derived device ID unique to the enterprise endpoint device 300 based on serial numbers or other identifying information from one or more of these hardware components (e.g., 370). For example, manufacturer of the enterprise endpoint device 300 may combine or apply a hash algorithm to serial numbers or other identifying information from one or more hardware components (e.g., 370) installed within the enterprise endpoint device 300 in one embodiment. In another embodiment, the hardware derived device ID may further be encrypted using a shared private key stored at the enterprise endpoint device 300 and at the management servers operating the ECM system. In still other embodiments, the hardware derived device ID may be further based on serial numbers or other identifying information for one or more software applications executed by the operating system 320 of the enterprise endpoint device 300. The enterprise endpoint device 300 may transmit this hardware derived device ID to the ECM system during a multi-level security check in order to gain access to a requested eSIM profile managed by the ECM system via a boot-strap, alternative wireless network connection. The hardware derived device ID or other serial numbers or other identifying information to permit encryption to a hardware derived device ID in an embodiment may be securely stored at the enterprise endpoint eSIM provisioning system, and the manufacturer of enterprise endpoint device 300. These identifiers may not be shared outside the enterprise system in some embodiments.

In some embodiments, the enterprise endpoint device 300 may generate the hardware derived device ID itself, based on instructions stored in firmware of one or more hardware components (e.g., firmware of the WLAN interface device 342) of the enterprise endpoint device 300. Such instructions may direct the hardware component (e.g., WLAN interface device 342) to access the eUICC information set and serial numbers for the one or more hardware components forming the basis of the hardware derived device ID, as stored in BIOS memory 360, via the enterprise endpoint eSIM provisioning virtual driver 311 in kernel mode. The hardware component (e.g., WLAN interface device 342) may further execute firmware instructions in an embodiment to combine, hash, or encrypt these serial numbers and eUICC information set according to a preset algorithm or method, according to the firmware code instructions.

In such an embodiment, the enterprise endpoint device 300 may be capable of generating an updated hardware derived device ID when any of the hardware components 370 whose serial numbers form the basis of the hardware derived device ID are replaced with other hardware components. The ECM system in such an embodiment may also track the authorized replacement of such hardware components for each managed endpoint device (e.g., 300). Thus, the ECM system may also use the same preset algorithm method to generate an updated hardware derived device ID for the enterprise endpoint device 300. However, if a hardware component (e.g., 370) is replaced without oversight from an enterprise administrator, or without updating the hardware components assigned to the enterprise endpoint device 300 as identified at the ECM system, the updated hardware derived device ID generated by the enterprise endpoint device 300 and the updated hardware derived device ID generated at the ECM system may not match, prompting the ECM system to deny the enterprise endpoint device 300 access to requested eSIM profiles.

The operating system 320 in an embodiment may be, for example, a Microsoft® Windows® operating system, an Apple MAC OS, or any other operating system currently known in the art. The operating system 320 may operate to transmit and receive Internet Protocol (IP) packets to and from the bridge 330. The NDIS bridge to a WDM 330 in an embodiment may operate to route IP packets received from a network driver (e.g., WLAN driver 340 or WWAN driver 350) to the operating system 320 for processing, or to route IP packets received from the operating system 320 to a network driver (e.g., WLAN driver 340 or WWAN driver 350) for later transmission via a network interface device. In embodiments in which the operating system in an Apple MAC OS, the NDIS bridge may be an NDIS wrapper that translates windows commands to non-windows instructions.

The network drivers (e.g., WLAN driver 340 or WWAN driver 350) in an embodiment may operate to process data frames received via the network interface devices (e.g., 342 or 352) to access IP packets encapsulated therein, and to route these IP packets, via the NDIS bridge to WDM 330, according to various headers within the received data frames. In another aspect of an embodiment, the network drivers (e.g., WLAN driver 340 or WWAN driver 350) may operate to receive IP packets, via the NDIS bridge to WDM 330, as well as various headers relating to the network layer, transport layer, session layer, and presentation layer, and process these packets and headers by applying one or more data link layer headers and apportioning the IP packet and all associated headers into a data frame compliant with the standard (e.g., WWAN or WLAN standards) by which an associated network interface device may transmit data.

For example, the WDM WLAN driver 340 in an embodiment may receive WLAN-compliant data frames via the WLAN interface device 342, strip the data link layer header(s) from an IP packet encapsulated within the WLAN-compliant data frame, and transmit the IP packet with remaining headers (e.g., network layer header, transport layer header, session layer header, presentation layer header, application layer header) to the NDIS bridge to WDM 330 for delivery to the operating system 320. The WDM WLAN driver 340 in such an embodiment may also receive IP packets encapsulated by various headers (e.g., network layer header, transport layer header, session layer header, presentation layer header, application layer header) and process the IP packets and associated headers into WLAN-compliant data frames, for transmission via the WLAN interface device 342.

As another example, the WDM WWAN driver 350 in an embodiment may receive WWAN-compliant data frames via the WWAN interface device 352, strip the data link layer header(s) from an IP packet encapsulated within the WWAN-compliant data frame, and transmit the IP packet with remaining headers (e.g., network layer header, transport layer header, session layer header, presentation layer header, application layer header) to the NDIS bridge to WDM 330 for delivery to the operating system 320. One or more of these IP packets ultimately delivered to the operating system 320 via the WWAN driver 350 in an embodiment may include instructions received via the WWAN interface device 352 from a remote mobile broadband network or RAN provider to transmit the eUICC information set for the enterprise endpoint device 300.

The WDM WWAN driver 350 in such an embodiment may also receive IP packets encapsulated by various headers (e.g., network layer header, transport layer header, session layer header, presentation layer header, application layer header) and process the IP packets and associated headers into WWAN-compliant data frames, for transmission via the WWAN interface device 352. The WWAN driver 350 may process the IP packets into WWAN-compliant data frames using some of the information stored within an eSIM profile assigned to the enterprise endpoint device 300, such as the IMSI or MSISDN. Further, the WWAN interface device 352 in an embodiment may transmit the WWAN-compliant data frame using some of this eSIM profile information. For example, the WWAN interface device 352 may instruct operation of the antenna systems using some of the various connectivity parameters for establishing a wireless link between the enterprise endpoint device 300 and the world wide web via the WWAN interface device 352.

The WLAN interface device 342 and WWAN interface device 352 in an embodiment may operate firmware capable of establishing a boot-strap wireless network connection to the ECM system. This type of boot-strap wireless network connection in an embodiment may be used for multiple purposes, including the enterprise endpoint device 300 performing periodic wireless check-ins with the ECM system, and the enterprise endpoint device 300 requesting the ECM system issue the enterprise endpoint device 300 an eSIM profile for communication via a mobile broadband network or RAN.

As described herein, the ECM system in an embodiment may routinely gather operation conditions from the enterprise endpoint device 300 in order to ensure maintenance of security measures and to gather performance metrics. Enterprise endpoint device 300 may check-in with the ECM system management servers in an embodiment, with check-in data including hardware derived device IDentification and reports of operation conditions or anticipated operation conditions for enterprise endpoint device 300. These operation conditions or anticipated operation conditions may be used to determine a type of wireless RAN or wireless service level to be assigned to the enterprise endpoint device 300. When any one of these operation conditions changes between such periodic wireless check-ins (e.g., due to a change in location, a change in users, or a change in one or more applications being executed), the enterprise endpoint device 300 may transmit an updated operation condition describing these changes during the next period wireless check-in. Managed endpoint device check-ins may be required periodically or when a boot-strap connection is available at the enterprise endpoint device 300.

As also described herein, the enterprise endpoint device 300 in an embodiment may use the boot-strap wireless network connection to request that the ECM system issue the enterprise endpoint device 300 an eSIM profile for communication via a mobile broadband network or RAN. In this context, the boot-strap wireless network connection may include any wired or wireless connection between the ECM system and the enterprise endpoint device 300 that does not proceed through the mobile broadband network or RAN for which the enterprise endpoint device 300 has requested an eSIM profile. For example, the boot-strap wireless network connection established between the enterprise endpoint device 300 and the ECM system to relay a request for an eSIM profile for a cellular network (e.g., WWAN network) may be established via the WLAN interface device 342 as the boot-strap wireless connection.

As another example embodiment, the boot-strap wireless network connection established between the enterprise endpoint device 300 and the ECM system to relay a request for an eSIM profile for a first cellular network (e.g., WWAN network) may be established via the WWAN interface device 342 and a second cellular network (e.g., WWAN) for which the enterprise endpoint device 300 has already been issued an eSIM profile. In other words, the WWAN interface device 352 may establish a wireless connection with the second cellular network without accessing any information within the requested, but not yet received, eSIM profile for the first WWAN network. In still another embodiment, the ECM system may establish a wired connection to the WLAN interface device 342, WWAN interface device 352, or related firmware, for example, during manufacture of the enterprise endpoint device 300. The wired or wireless boot-strap wireless network connection so formed according to various embodiments described herein may form an authenticated BIO interface between the ECM system and the enterprise endpoint device 300.

The WWAN interface device 352 or the WLAN interface device 342 in an embodiment may also operate at least a portion of the enterprise endpoint eSIM provisioning system (e.g., an agent or firmware operating at a network interface card (NIC)) to retrieve the eUICC information set unique to the eUICC 312 or the hardware derived device ID (as described above with respect to FIG. 2) stored in BIOS memory 360, via the enterprise endpoint eSIM provisioning virtual driver 311. As described herein, the enterprise endpoint device 300 may identify itself to the ECM system during a request for an eSIM profile using either or both the unique hardware derived device ID or the eUICC information set. As such, the enterprise endpoint device 300 may retrieve both or only one of these identifiers, based on which one the enterprise endpoint device 300 transmits to the ECM system along with the request for an eSIM profile in order to prove the identity of the enterprise endpoint device 300.

This retrieval may be executed only in kernel mode in an embodiment. As such, retrieval of such information stored in BIOS memory 360 may not be achieved via instructions executed by the operating system 320. This provides an enhanced security by disabling the ability of remote or external agents to “spoof” or counterfeit the identity of the enterprise endpoint device 300 when requesting assignment of an eSIM profile.

Upon retrieval of the eUICC information set or unique hardware derived device IDentifier in such a way, the WWAN interface device 352 or the WLAN interface device 342 may execute code instructions within firmware for that interface device (e.g., 342 or 352) to transmit the retrieved eUICC information set or hardware derived device ID along with a request for access to an eSIM profile to a remote enterprise endpoint eSIM provisioning system located at the ECM system (e.g., as described with reference to FIG. 2). If the remote enterprise endpoint eSIM provisioning system in such an embodiment authenticates the enterprise endpoint device 300, the remote enterprise endpoint eSIM provisioning system may establish an authenticated BIOS interface with the enterprise endpoint eSIM provisioning virtual driver 311, via the boot-strap wireless network connection with the WLAN interface device 342 (or WWAN interface device 352), in order to transmit and store the requested eSIM profile in BIOS memory 360. The BIOS memory 360 in such an embodiment may comprise a secure flash memory. Once the requested eSIM profile has been stored in BIOS memory 360 in an embodiment, the ECM system may notify the operating system 320 that an eSIM profile has been received and stored at the enterprise endpoint device 300.

The WWAN interface device 352 may access the stored eSIM profile in the BIOS memory 360 via the enterprise endpoint eSIM provisioning virtual driver 311 in an embodiment, in order to establish a wireless connection with the provider of the mobile broadband network or RAN that provided the requested eSIM profile. The eSIM profile may include instructions or information for establishing a secure connection between the WWAN interface device 352 and a remote mobile broadband network or RAN provider (e.g., as described with reference to FIG. 2). The WWAN interface device 352 may establish such a secure connection with the remote mobile broadband network provider by transmitting the eUICC information set retrieved from BIOS memory 360 earlier, in a request for the mobile broadband network or RAN provider to enable the eSIM profile also stored at BIOS memory 360 for WWAN access. Upon such an enablement of the eSIM profile by the mobile broadband network or RAN provider, the enterprise endpoint device 300 may begin wireless communications with the world wide web via a wireless connection established by the WWAN interface device with the mobile broadband network or RAN, using the various communication parameters stored within the now-enabled eSIM profile stored in BIOS memory 360.

In some embodiments, the enterprise endpoint device 300 may include a plurality of WWAN interface devices 352, each capable of transceiving data according to information stored within a separate eSIM profile. For example, the enterprise endpoint eSIM provisioning system in an embodiment may establish the authenticated BIOS interface described above in order to store a plurality of eSIM profiles within BIOS memory 360, with each eSIM profile identifying a separate IMSI or MSISDN (e.g., where each eSIM profile is purchased from a separate mobile broadband network or RAN provider). In such an embodiment, the process of the WWAN interface device accessing the eSIM profile stored in BIOS memory 360, transmitting a request for enabling of the eSIM profile to the mobile broadband network or RAN provider, and transceiving of data pursuant to connectivity parameters outlined with the now-enabled eSIM profile may be repeated for each of the plurality of WWAN interface devices (e.g., 352). In such a way, each of the plurality of WWAN interface devices (e.g., 352) in such an embodiment may transceive according to a separate eSIM profile stored in BIOS memory 360, each including a different IMSI or MSISDN, and potentially purchased from a separate mobile broadband network or RAN provider.

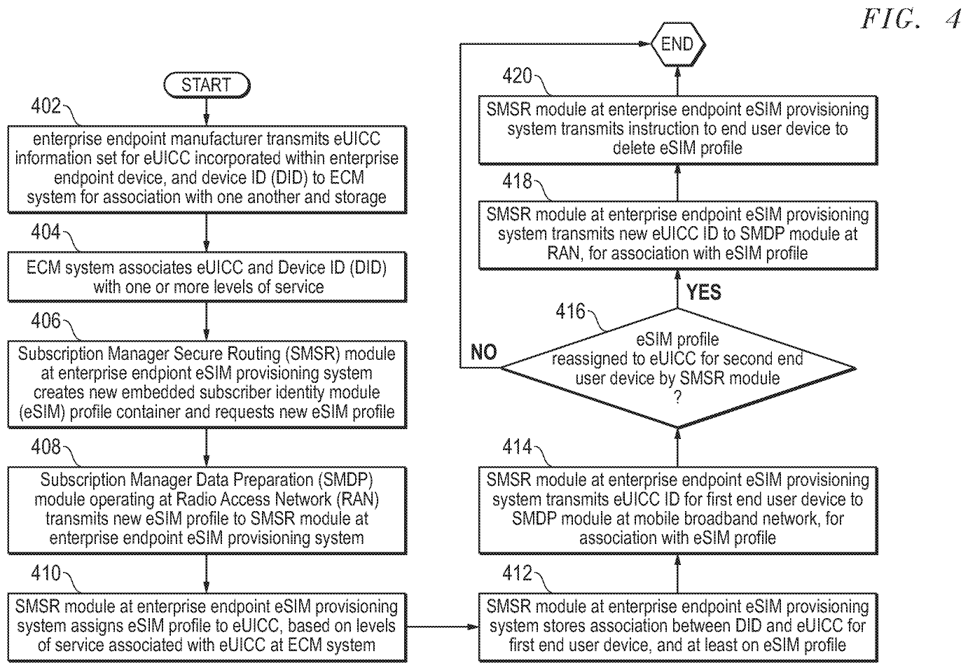

FIG. 4 is a flow diagram illustrating a method of provisioning an enterprise endpoint device with an eSIM profile based on levels of service associated with the enterprise endpoint device at a an enterprise client management (ECM) system according to an embodiment of the present disclosure. As described herein, the emerging 5G standard's support for remote delivery of eSIM profiles permits embodiments described in the present disclosure for provisioning eSIM profiles with an ECM system (e.g., a cloud client management (CCM) platform) to an enterprise endpoint device and presents an opportunity to optimize use of eSIM profiles across a plurality of enterprise endpoint devices. The enterprise endpoint eSIM provisioning system in embodiments of the present disclosure may operate within, or in tandem with the ECM system to enable such optimization. The ECM system in an embodiment may manage, via one or more management servers, assignment and delivery of a pool of eSIM profiles, purchased by the enterprise, to the plurality of enterprise endpoint devices. Enabling a single platform or system to manage the eSIM profiles for each of the enterprise endpoint devices in such a way may allow for optimized use of each of the eSIM profiles within the purchased pool.

At block 402, the enterprise endpoint manufacturer in an embodiment may transmit an embedded universal integrated circuit card (eUICC) information set for an eUICC incorporated within a first enterprise endpoint device, and a hardware derived device ID or serial numbers or the like for encryption into a hardware derived device ID for the first enterprise endpoint device to an ECM system. The ECM system in such an embodiment may store the eUICC information set and the hardware derived device ID or serial numbers or the like for encryption into a hardware derived device ID for the first enterprise endpoint device and associate them with one another to indicate the first enterprise endpoint device associated with the received hardware derived device ID includes the eUICC identified within the received eUICC information set. For example, in an embodiment described with reference to FIG. 2, the enterprise endpoint device manufacturer 210 in an embodiment may transmit the eUICC information set unique to the eUICC 242 and a hardware derived device ID unique to the one or more additional hardware components (e.g., 244) installed in the enterprise endpoint device 240. Each eUICC 242 placed into an enterprise endpoint device 240 in such a way may be associated with a unique identification applied by the eUICC manufacturer, called an eUICC information set. Each of the other hardware components may also be associated with a serial number or other identifying code. The enterprise endpoint device manufacturer 210 in an embodiment may generate a hardware derived device ID unique to the enterprise endpoint device based on a combination of the serial numbers or other identification numbers from one or more of these hardware components. For example, the enterprise endpoint device manufacturer 210 in an embodiment may combine or apply a hash algorithm to a combination of the serial numbers or other identification numbers from one or more hardware components installed within the enterprise endpoint device 240. In another embodiment, the hardware derived device ID may further be encrypted using a shared private key stored at the enterprise endpoint device 240 and at the management servers operating the ECM system 230.

The ECM system in an embodiment may associate the eUICC and hardware derived device ID for the first enterprise endpoint device with one or more levels of service at block 404. For example, in an embodiment described with reference to FIG. 2, operation conditions for the enterprise endpoint device 240 may be used to determine a type of wireless RAN or wireless service level to be assigned to an endpoint device. The levels of wireless service in an embodiment may be defined by setting one or more minimum requirements for wireless link quality. For example, a level of wireless service in an embodiment may identify a throughput requirement as a minimum requirement. In other embodiments, requirements associated with another connectivity parameter within a level of wireless service, such as a quality of service (QoS) rating, a number of dropped packets, or latency may be identified as a minimum requirement.

Operation conditions in an embodiment may include, for example, the geographic or physical location of the enterprise endpoint device 240, or an identification of the user currently logged into the enterprise endpoint device 240 (or anticipated to be logged on before the next scheduled check-in). In another example, operation conditions transmitted from the enterprise endpoint device 240 to the ECM system 230 may include identification of applications either currently running or whose execution is imminently anticipated.

Upon initial setup of the enterprise endpoint device 240 (e.g., by an administrator of the ECM system 230), the level of wireless service may be assigned to the enterprise endpoint device 240 based on the user to which it is assigned, or the applications available to that user via the enterprise endpoint device 240. The levels of wireless service associated with the enterprise endpoint device 240 may change following this initial setup based upon changes in one or more of these operation conditions. For example, the enterprise endpoint device may undergo a change in physical location, a change in users, or a change in executing applications. One or more of these changes may trigger an associated change in the level of wireless service assigned to the enterprise endpoint device 240 at any given time in an embodiment.

At block 406, the subscription manager secure routing module at the enterprise endpoint eSIM provisioning system in an embodiment may create a new embedded subscriber identity module (eSIM) profile container and request a new eSIM profile from a mobile broadband network or RAN provider. In other embodiments, the eSIM profiles may already be requested and stored in a pool for access and distribution by the enterprise endpoint eSIM provisioning system. In one example embodiment, the secure routing subscription manager 234 may transmit a request to the mobile broadband network or RAN 250 for an eSIM profile purchased by the enterprise. As part of this request, the secure routing subscription manager 234 may include the eUICC information set unique to the eUICC 242 of a single enterprise endpoint device 240. In another embodiment, the secure routing subscription manager 234 may access the pool of eSIM profiles previously acquired and notify the mobile broadband network or RAN provider system of the eUICC information set to be associated with an eSIM profile.

The subscription manager data preparation module operating at a RAN or mobile broadband network in an embodiment may transmit a new eSIM profile to the subscription manager secure routing module at the enterprise endpoint eSIM provisioning system at block 408. For example, the data preparation subscription manager 252 operating at the mobile broadband network or RAN 250 in an embodiment may generate an eSIM profile including the eUICC information set received from the secure routing subscription manager 234, an International Mobile Subscriber Identification (IMSI), a mobile station international subscriber directory number (MSISDN), and various connectivity parameters for establishing a wireless link between the enterprise endpoint device 240 and the world wide web 220 via the mobile broadband network or RAN 250. The eSIM profile so generated may also include information used to establish a secure channel between the enterprise endpoint device 240 and the data preparation subscription manager 252. In embodiments where a pool of eSIM profiles have been acquired previously by the enterprise endpoint eSIM provisioning system, the subscription manager data preparation module operating at a RAN or mobile broadband network may be simply notified to associate the assigned eSIM profile with the eUICC information set as described with respect to block 414 below for enabling the use of the eSIM profile for RAN access by the managed enterprise endpoint device.

At block 410, the subscription manager secure routing module at the enterprise endpoint eSIM provisioning system in an embodiment may assign an eSIM profile to the first enterprise endpoint hardware derived device IDentified with an eUICC information set and a hardware derived device ID, based on levels of service associated with the first enterprise endpoint device at the ECM system. For example, the enterprise endpoint eSIM provisioning system 232 in an embodiment may assign eSIM profiles to enterprise endpoint devices (e.g., 240) based, at least in part, on the operation conditions gathered from each of the plurality of enterprise endpoint devices managed by the ECM system 230. For example, the assignment of a given eSIM profile to a given enterprise endpoint device (e.g., 240) in an embodiment may be made based on the geographic location of the enterprise endpoint device, an identification of the user logged into the enterprise endpoint device, or upon software applications running at the enterprise endpoint device, as described in the check-in data reported to the ECM system 230 during required periodic wireless check-ins.

Each of these operation conditions, or combinations of these operation conditions may be associated with minimum levels of wireless service. For example, some users (e.g., enterprise corporate officers, test engineers, sales representatives frequently performing demonstrations of robust software for clients) may be associated with higher levels of wireless service than others. As another example, certain applications may require more reliable, or faster wireless signals in order to successfully execute, causing some applications to be associated with higher levels of wireless service than others. As yet another example, some geographic locations may receive stronger signals than others, causing the minimum level of wireless service associated with geographic locations receiving weaker signals to be lower than the minimum level of wireless service associated with geographic locations receiving stronger signals.

The subscription manager secure routing module at the enterprise endpoint eSIM provisioning system in an embodiment may store an association between the hardware derived device ID and the eUICC information set of the first enterprise endpoint device with at least one eSIM profile at block 412. For example, the subscription manager secure routing module may associate the hardware derived device ID and eUICC information for a given enterprise endpoint device, as received at block 402, with the eSIM profile received from the subscription manager data preparation module at block 408. The enterprise endpoint eSIM provisioning system in an embodiment may require an enterprise endpoint device requesting access to a given eSIM profile associated therewith at the ECM system to provide one or both of these forms of identification associated with that eSIM profile. The hardware derived device ID for the enterprise endpoint device may be generated based on a serial number for a hardware component incorporated within the enterprise endpoint device (or combinations or a plurality of such serial numbers for a plurality of components), which may only be accessible by the enterprise endpoint device operating in kernel mode. Thus, requiring proof of the hardware derived device ID may provide a layer of security difficult to spoof against outside attempts (e.g., by entities outside the enterprise) to gain access to the eSIM profile by counterfeiting the eUICC information set.

At block 414, the subscription manager secure routing module at the enterprise endpoint eSIM provisioning system in an embodiment may transmit the eUICC information set for the first enterprise endpoint device to the subscription manager data preparation module at the mobile broadband network provider, for association with the eSIM profile transmitted to the ECM system. The subscription manager data preparation module in an embodiment may later use this information to authenticate the identity of the enterprise endpoint device seeking access to the mobile broadband RAN via the eSIM profile. As described herein, the eSIM profile initially transmitted to the enterprise endpoint device via the subscription manager secure routing module may have yet to be enabled. The enterprise endpoint device may later request that the subscription manager data preparation module enable the eSIM profile such that the enterprise endpoint device may use the included IMSI or MSISDN to establish a wireless RAN connection. Prior to enabling the eSIM profile, the subscription manager data preparation module may require the enterprise endpoint device to provide the eUICC information set stored within the BIOS memory of the enterprise endpoint device. The subscription manager data preparation module in an embodiment may then only enable the eSIM profile transmitted to the enterprise endpoint device if the eUICC information set received from the enterprise endpoint device matches the eUICC information set received from the subscription manager secure routing module and associated with the requested eSIM profile at the RAN provider. Thus, the previously assigned eSIM profile described above may be reassigned to another managed, enterprise endpoint device by the ECM system and the enterprise endpoint eSIM provisioning system to flexibly utilize available eSIM profiles within the enterprise.

The enterprise endpoint eSIM provisioning system in an embodiment may determine at block 416 whether the eSIM profile received from the mobile broadband network or RAN provider has been reassigned to a second enterprise endpoint device by the subscription manager secure routing module. As described herein, for example in an embodiment described with reference to FIG. 2, the enterprise endpoint eSIM provisioning system 232 may work in tandem with the ECM system 230 to optimally distribute eSIM profiles from a plurality of mobile broadband networks or RANs (e.g., 250) across a plurality of enterprise endpoint devices (e.g., 240) in a cost effective manner that satisfies minimum level of wireless service for the plurality of enterprise endpoint devices.

Further, as operation conditions at a given enterprise endpoint device change, so too may the level of wireless service for that enterprise endpoint device, potentially prompting a change from a first eSIM profile that is not capable of meeting the updated level of wireless service to a second eSIM profile that is capable of meeting the updated level of wireless service. For example, the enterprise endpoint device 240 may routinely travel from a first office, where AT&T® has the best coverage, to a second office, where Verizon® has the best coverage. In such an example embodiment, the enterprise endpoint eSIM provisioning system 232 may operate to assign and transmit to the enterprise endpoint device 240 an eSIM profile from the pool of profiles purchased from mobile broadband network or RAN 250 which may be owned and operated by AT&T®, just prior to the scheduled travel to the first office (or upon request by the employee just prior to her travel to the first office). Upon the employee's departure from the first office to the second office, the enterprise endpoint eSIM provisioning system 232 in such an embodiment may revoke the AT&T® eSIM profile assigned to the enterprise endpoint device 240, and assign and transmit to the enterprise endpoint device 240 an eSIM profile from the pool of profiles purchased from Verizon®.

This additionally allows the enterprise endpoint eSIM provisioning system 232 to reassign the revoked AT&T® eSIM profile to another enterprise endpoint device currently exhibiting a greater need for access to the AT&T® network 250. If the eSIM profile received from the mobile broadband network or RAN provider has been reassigned to a second enterprise endpoint device by the subscription manager secure routing module, the method may proceed to block 418 to update records stored at the mobile broadband network provider and disable the first enterprise endpoint device's access to the eSIM profile. If the eSIM profile received from the mobile broadband network or RAN provider has not been reassigned to a second enterprise endpoint device by the subscription manager secure routing module, the method for provisioning the first enterprise endpoint device with an eSIM profile, based on levels of wireless service associated with the first enterprise endpoint device may end.

At block 418, the subscription manager secure routing module at the enterprise endpoint eSIM provisioning system may transmit a new eUICC ID associated at the ECM system with the second enterprise endpoint device to the subscription manager data preparation module at the RAN provider, for association with the eSIM profile managed by the RAN provider. The subscription manager data preparation module at the RAN provider in such an embodiment may use this new eUICC ID to authenticate the second enterprise endpoint device when it requests that the RAN provider enable the eSIM profile, as reassigned and delivered to the second enterprise endpoint device.

The subscription manager secure routing module at the enterprise endpoint eSIM provisioning system in an embodiment may transmit instructions to the first end user device to delete or overwrite the eSIM profile from secure BIOS at the first enterprise endpoint device at block 420. In order to ensure that two devices are not simultaneously using the same eSIM profile in an embodiment, the subscription manager secure routing module may instruct the first enterprise endpoint device to delete or overwrite the eSIM profile from its BIOS memory prior to assignment by the subscription manager secure routing module of this same eSIM profile to a second enterprise endpoint device. This deletion instruction may be transmitted using the authenticated BIOS interface established using a boot-strap wireless network connection described herein. The method may then end. In such a way, the enterprise endpoint eSIM provisioning system may work in tandem with the ECM system to optimally distribute eSIM profiles from a plurality of mobile broadband networks or RANs across a plurality of enterprise endpoint devices in a cost effective manner that satisfies minimum level of wireless service for the plurality of enterprise endpoint devices.

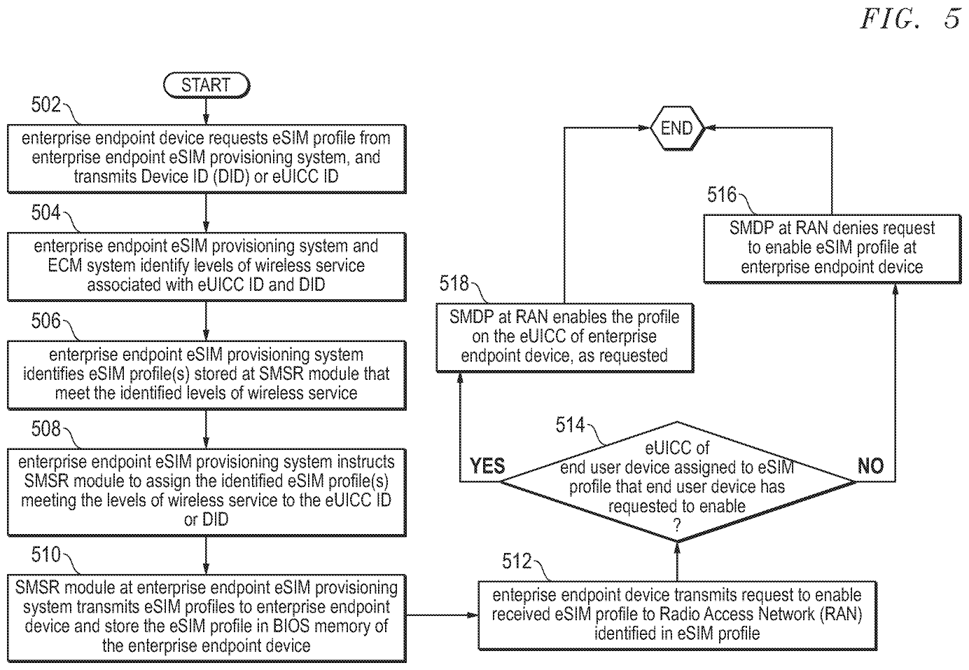

FIG. 5 is a flow diagram illustrating a method of a RAN provider enabling an eSIM profile provisioned to an enterprise endpoint device by an ECM system, based on operation conditions for the enterprise endpoint device according to an embodiment of the present disclosure. As described herein, the eSIM profile initially received by the enterprise endpoint device from the subscription manager secure routing module of the enterprise endpoint eSIM provisioning system may not yet be enabled. The enterprise endpoint device in an embodiment may need to request that the eSIM profile so received be enabled by the RAN provider of the eSIM profile, prior to the enterprise endpoint device using the eSIM profile to access the RAN.

At block 502, in an embodiment, the enterprise endpoint device may request an eSIM profile from an enterprise endpoint eSIM provisioning system, and transmit one or both of an eUICC information set and hardware derived device ID for the enterprise endpoint device. For example, in an embodiment described with reference to FIG. 3, the enterprise endpoint device 300 in an embodiment may use a boot-strap wireless network connection to request that the ECM system (e.g., a CCM platform) issue the enterprise endpoint device 300 an eSIM profile for communication via a mobile broadband network or RAN. The WLAN interface device 342 and WWAN interface device 352 in an embodiment may operate firmware capable of establishing a boot-strap wireless network connection to the ECM system. In this context, the boot-strap wireless network connection may include any wired or wireless connection between the ECM system and the enterprise endpoint device 300 that does not proceed through the mobile broadband network or RAN for which the enterprise endpoint device 300 has requested an eSIM profile. For example, the boot-strap wireless network connection established between the enterprise endpoint device 300 and the ECM system to relay a request for an eSIM profile for a cellular network (e.g., WWAN network) may be established via the WLAN interface device 342 as the boot-strap wireless network connection.

The WLAN interface device 342 in an embodiment may also operate at least a portion of the enterprise endpoint eSIM provisioning system (e.g., an agent or firmware operating at a network interface card (NIC)) to retrieve the eUICC information set unique to the eUICC 312 or the hardware derived device ID (as described above with respect to FIG. 2) stored in BIOS memory 360, via the enterprise endpoint eSIM provisioning virtual driver 311. This retrieval may be executed only in kernel mode in an embodiment. As such, retrieval of such information stored in BIOS memory 360 may not be achieved via instructions executed by the operating system 320. This provides an enhanced security by disabling the ability of remote or external agents to “spoof” or counterfeit the identity of the enterprise endpoint device 300 when requesting assignment of an eSIM profile. Upon retrieval of the eUICC information set or physically applied identifier in such a way, the WLAN interface device 342 may execute code instructions within firmware for that interface device (e.g., 352) to transmit the retrieved eUICC information set or hardware derived device ID along with a request for access to an eSIM profile to a remote enterprise endpoint eSIM provisioning system located at the ECM system.

For example, as described with reference to FIG. 2, the enterprise endpoint computing device 240 may transmit some form of identification of the enterprise endpoint computing device 240 to the secure routing subscription manager 234. As described herein, the enterprise endpoint computing device 240 in an embodiment may transmit to the secure routing subscription manager 234, for example, the unique hardware derived device ID generated based on serial numbers or other identifying information of one or more hardware components 244 incorporated within the enterprise endpoint device 240. In another embodiment, the enterprise endpoint computing device 240 may transmit to the secure routing subscription manager 234 the eUICC information set unique to the eUICC 242 as a form of identification for the enterprise endpoint device 240. In still other embodiments, the enterprise endpoint device 240 may transmit to the secure routing subscription manager 234 both the unique hardware derived device ID and the eUICC information set.

The enterprise endpoint eSIM provisioning system located at or working in tandem with an ECM system in an embodiment may identify levels of wireless service associated with the received eUICC information set or hardware derived device ID at block 504. For example, as described above with respect to block 404 of FIG. 4, the ECM system in an embodiment may have previously associated the eUICC and hardware derived device ID for the first enterprise endpoint device with one or more levels of service. In an embodiment described with reference to FIG. 2, for example, operation conditions for the enterprise endpoint device 240 may be used to determine a type of wireless RAN or wireless service level to be assigned to an endpoint device. The levels of wireless service in an embodiment may be defined by setting one or more minimum requirements for wireless link quality. For example, a level of wireless service in an embodiment may identify a throughput requirement as a minimum requirement. In other embodiments, requirements associated with another connectivity parameter within a level of wireless service, such as a quality of service (QoS) rating, a number of dropped packets, or latency may be identified as a minimum requirement.

At block 506, the enterprise endpoint eSIM provisioning system in an embodiment may identify an eSIM profile stored at the subscription manager secure routing module that meets the identified levels of wireless service. This determination may be made in an embodiment, at least in part, based on high-level metrics describing quality of service for a plurality of wireless links established across a plurality of enterprise endpoint devices using a plurality of RANs. Such high-level metrics may be generated in an embodiment based on check-in data routinely retrieved from the plurality of enterprise endpoint devices. For example, in an embodiment described with reference to FIG. 2, the ECM system 230 in an embodiment may routinely gather operation conditions from endpoint devices (e.g., including 240) in order to ensure maintenance of security measures and to gather performance metrics at each of these enterprise endpoint devices (e.g., including 240). Enterprise endpoint device 240 may check-in with the ECM system management servers 230 in an embodiment, with check-in data including wireless link state information and endpoint configuration data (e.g., including eSIM profiles used to establish wireless links).

The ECM system 230 in an embodiment may store this wireless link state information, eSIM profiles used to establish such wireless links, as well as operation conditions such as geographic locations of enterprise endpoint devices (e.g., 240), logged in users, or operating software applications at the time such data is gathered. The enterprise may gather such information from a plurality of enterprise endpoint devices (e.g., 240), some of which may be in transit, dispersed across large geographic areas, and communicating via a plurality of mobile broadband networks or RANs (e.g., 250). Analysis of a compilation of data gathered from each of the plurality of enterprise endpoint devices may thus provide a high-level estimate of wireless link quality in a given location, established via a specific mobile broadband network or RAN (e.g., 250). The enterprise endpoint eSIM provisioning system may refer to these high-level estimates of wireless link quality for the current (or anticipated long-term) location of the enterprise endpoint device to identify a specific mobile broadband network or RAN (e.g., 250) capable of providing wireless links meeting the level of wireless service associated with the enterprise endpoint device (as identified by its eUICC information set or hardware derived device ID) at the ECM system.

The enterprise endpoint eSIM provisioning system in an embodiment may instruct the subscription manager secure routing module to assign the identified eSIM profile meeting the levels of wireless service to the enterprise endpoint hardware derived device IDentified by the eUICC information set or hardware derived device ID at block 508. For example, in an embodiment described with reference to FIG. 2, the enterprise endpoint eSIM provisioning system 232 in an embodiment may instruct the subscription manager secure routing module 234 to assign the eSIM profile identified at block 506 as meeting the levels of wireless service to the enterprise endpoint device (e.g., 240) identified by the eUICC information set or hardware derived device ID associated with those levels of wireless service at the ECM system 230.

At block 510, the subscription manager secure routing module at the enterprise endpoint eSIM provisioning system may transmit the eSIM profile meeting the levels of wireless service to the enterprise endpoint device. This may occur in an embodiment upon authentication of the enterprise endpoint device. For example, the enterprise endpoint eSIM provisioning system may first ensure that the eUICC information set and/or the hardware derived device ID received from the enterprise endpoint device (e.g., as described with respect to block 502) are associated with one another within the ECM system. As described herein, the hardware derived device ID may be generated based on serial numbers for hardware components (e.g., 370) incorporated within the enterprise endpoint device 300, other than the eUICC 312. The ECM system in an embodiment may track the authorized replacement of such hardware components (e.g., 370) for each managed endpoint device (e.g., 300). If a hardware component (e.g., 370) is replaced without oversight from an enterprise administrator, or without updating the hardware components assigned to the enterprise endpoint device 300 as identified at the ECM system, the hardware derived device ID provided by the enterprise endpoint device 300 and the hardware derived device ID generated at the ECM system may not match, prompting the ECM system to deny the enterprise endpoint device 300 access to requested eSIM profiles.

In contrast, the ECM system may positively authenticate the enterprise endpoint device if the hardware derived device ID provided by the enterprise endpoint device 300 matches the hardware derived device ID associated with the eUICC information set also provided by the enterprise endpoint device 300 at the ECM system. Upon the remote enterprise endpoint eSIM provisioning system authenticating the enterprise endpoint device 300 (e.g., using the eUICC ID and hardware derived device ID received at block 502), the remote enterprise endpoint eSIM provisioning system may establish an authenticated BIOS interface with the enterprise endpoint eSIM provisioning virtual driver 311, via the boot-strap wireless network connection with the WLAN interface device 342 or WWAN interface device 352, in order to store the requested eSIM profile in BIOS memory 360.

At block 512, the enterprise endpoint device may transmit a request to enable the received eSIM profile to a RAN provider identified within the received and stored eSIM profile. As described herein with respect to FIG. 2, the eSIM profile stored at BIOS memory for the enterprise endpoint device may include at least the IMSI, MSISDN, and information used to establish the secure channel with the mobile broadband network or RAN 250 to the enterprise endpoint device 240. The enterprise endpoint device 240 in an embodiment may establish a secure channel with the data preparation subscription manager 252 of the mobile broadband network or RAN 250 using the information stored within the eSIM profile delivered to the enterprise endpoint device 240 by the secure routing subscription manager 234.

For example, in an embodiment described with reference to FIG. 3, the WWAN interface device 352 may access the stored eSIM profile in the BIOS memory 360 via the enterprise endpoint eSIM provisioning virtual driver 311 in an embodiment, in order to establish a wireless connection with the provider of the mobile broadband network or RAN that provided the requested eSIM profile. The WWAN interface device 352 may establish such a secure connection with the remote mobile broadband network provider, transmit the eUICC information set retrieved from BIOS memory 360, and a request for the mobile broadband network or RAN provider to enable the eSIM profile also stored at BIOS memory 360.

The RAN provider in an embodiment may determine at block 514 whether the eUICC information set provided by the enterprise endpoint device matches an eUICC information set associated with the eSIM profile the enterprise endpoint device is requesting to enable. For example, in an embodiment described with reference to FIG. 2, the data preparation subscription manager 252 may authenticate the enterprise endpoint device 240, including at least a determination that the eUICC information set unique to the eUICC 242 received from the enterprise endpoint device 240 matches the eUICC information set stored within the eSIM profile at the data preparation subscription manager 252. If the eUICC information set provided by the enterprise endpoint device matches the eUICC information set associated with the eSIM profile the enterprise endpoint device is requesting to enable, this may indicate the enterprise endpoint device has been authorized by ECM system to use the eSIM profile, and the method may proceed to block 518 for enabling of the eSIM profile. If the eUICC information set provided by the enterprise endpoint device does not match the eUICC information set associated with the eSIM profile the enterprise endpoint device is requesting to enable, this may indicate the enterprise endpoint device has not been authorized by ECM system to use the eSIM profile, and the method may proceed to block 516 for denial of the request to enable the eSIM profile.

The subscription manager data processing module at the RAN provider in an embodiment in which the eUICC information set transmitted by the enterprise endpoint device does not match the eUICC information set associated with the requested eSIM profile may deny the request to enable the eSIM profile stored at the enterprise endpoint device at block 516. Failure to provide an eUICC information set matching the eUICC associated with the requested eSIM profile in an embodiment may indicate that the requesting enterprise endpoint device is not the device to which the enterprise endpoint eSIM provisioning system has assigned that eSIM profile. In such a scenario, the RAN provider in an embodiment may deny the request from the unknown device to enable the eSIM profile. The IMSI or MSISDN associated with that eSIM profile in such an embodiment may also be disabled in some cases. The RAN provider in some embodiments may additionally transmit a notification to the enterprise endpoint eSIM provisioning system of the failed attempt on the part of the unknown device to enable the eSIM profile. The method for enabling an eSIM may then end for the unauthorized or unknown device.

At block 518, the subscription manager data processing module at the RAN provider may enable the eSIM profile on the enterprise endpoint device, as requested. For example, once the enterprise endpoint device 240 has been authenticated, the data preparation subscription manager 252 may enable the eSIM profile transmitted from the data preparation subscription manager 252 to the enterprise endpoint device 240 via the enterprise endpoint eSIM provisioning system 232. At this point, the IMSI or MSISDN within the eSIM profile associated with the enterprise endpoint device 240 may be activated, such that the enterprise endpoint device 240 may use the credentials (e.g., IMSI or MSISDN) within the enabled eSIM profile to access the world wide web 228. The method for enabling an eSIM profile at an enterprise endpoint device in an embodiment may then end.

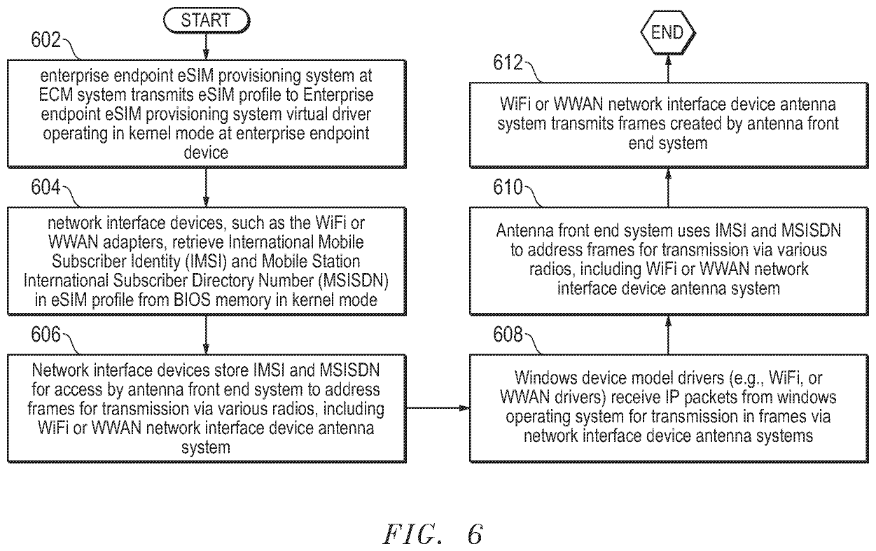

FIG. 6 is a flow diagram illustrating a method of an enterprise endpoint device transceiving data using an eSIM profile provisioned by the enterprise endpoint eSIM provisioning system, based on levels of wireless service associated with the enterprise endpoint device according to an embodiment of the present disclosure. At block 602, the enterprise endpoint eSIM provisioning system operating within or in tandem with an ECM system in an embodiment may transmit an eSIM profile to an enterprise endpoint eSIM provisioning system virtual driver operating in kernel mode at an enterprise endpoint device. For example, in an embodiment described with reference to FIG. 3, upon the remote enterprise endpoint eSIM provisioning system authenticating the enterprise endpoint device 300 (e.g., as described with reference to FIG. 5 at block 510), the remote enterprise endpoint eSIM provisioning system may establish an authenticated BIOS interface with the enterprise endpoint eSIM provisioning virtual driver 311, via the boot-strap wireless network connection with the WLAN interface device 342 (or WWAN interface device 352), in order to transmit the requested eSIM profile for storage in BIOS memory 360 of the enterprise endpoint device to which it is assigned. Once the requested eSIM profile has been stored in BIOS memory 360 in an embodiment, the operating system 320 of the enterprise endpoint device may be notified that an eSIM profile has been received and stored at the enterprise endpoint device 300.

One or more network interface devices in an embodiment may retrieve the international mobile subscriber identity (IMSI) or mobile station international subscriber directory number (MSISDN) from the received eSIM profile from BIOS memory in kernel mode at block 604. As described herein, the WWAN driver 350 may process IP packets received from the WWAN driver 350 into WWAN-compliant data frames using some of the information stored within an eSIM profile assigned to the enterprise endpoint device 300, such as the IMSI or MSISDN. The WLAN interface device 342 in an example embodiment may access the BIOS memory 360 via the enterprise endpoint eSIM provisioning virtual driver 311 in order to retrieve the IMSI or MSISDN from the eSIM profile stored at the BIOS memory 360 (e.g., as described with reference to block 602). As another example, the WWAN interface device 352 may access the BIOS memory 360 via the enterprise endpoint eSIM provisioning virtual driver 311 in order to retrieve the IMSI or MSISDN. In some embodiments, the WWAN interface device 352 or WLAN interface device 342 may similarly access the BIOS memory 360 to retrieve other connectivity requirements outlined within the eSIM profile.

At block 606, the network interface device may store the IMSI and MSISDN for access by an antenna front end system to address frames for transmission via various radios, including WLAN or WWAN interface device antenna systems. As described herein, the WWAN interface device 352 in an embodiment may transmit the WWAN-compliant data frame using some of this eSIM profile information. For example, the WWAN interface device 352 may instruct operation of the antenna systems using some of the various connectivity parameters for establishing a wireless link between the enterprise endpoint device 300 and the world wide web via the WWAN interface device 352 and the mobile broadband RAN network for which the eSIM profile has been received by the enterprise endpoint device.

The OS device model drivers (e.g., WLAN or WWAN drivers) in an embodiment may receive IP packets from an operating system for transmission in frames via a network interface device antenna system at block 608. The network drivers (e.g., WLAN driver 340 or WWAN driver 350) in an embodiment may operate to receive IP packets, via the NDIS bridge to WDM 330, as well as various headers relating to the network layer, transport layer, session layer, and presentation layer, and process these packets and headers by applying one or more data link layer headers and apportioning the IP packet and all associated headers into a data frame compliant with the standard (e.g., WWAN or WLAN standards) by which an associated network interface device may transmit data. For example, the WDM WLAN driver 340 in an embodiment may receive IP packets encapsulated by various headers (e.g., network layer header, transport layer header, session layer header, presentation layer header, application layer header) and process the IP packets and associated headers into WLAN-compliant data frames, for transmission via the WLAN interface device 342.

As another example, the WDM WWAN driver 350 in an embodiment may also receive IP packets encapsulated by various headers (e.g., network layer header, transport layer header, session layer header, presentation layer header, application layer header) and process the IP packets and associated headers into WWAN-compliant data frames, for transmission via the WWAN interface device 352. The WWAN driver 350 may process the IP packets into WWAN-compliant data frames using some of the information stored within an eSIM profile assigned to the enterprise endpoint device 300, such as the IMSI or MSISDN.

At block 610, the antenna front end system of the enterprise endpoint device may use the IMSI or MSISDN to address frames for transmission via various radios, including WLAN or WWAN interface device antenna systems. For example, the WWAN interface device 352 in an embodiment may transmit the WWAN-compliant data frame generated at block 608 using some of this eSIM profile information retrieved at block 604. More specifically, the WWAN interface device 352 may instruct operation of the antenna systems using some of the various connectivity parameters for establishing a wireless link between the enterprise endpoint device 300 and the world wide web via the WWAN interface device 352, including, for example, the IMSI or MSISDN.

The WLAN or WWAN interface device antenna systems in an embodiment may transmit frames created by the antenna front end system at block 612. For example, upon enablement of the eSIM profile by the mobile broadband network or RAN provider, the enterprise endpoint device 300 may begin wireless communications with the world wide web via a wireless connection established by the WWAN interface device with the mobile broadband network or RAN, using the various communication parameters stored within the now-enabled eSIM profile stored in BIOS memory 360. The method may then end.

The blocks of the flow diagrams of FIGS. 4-6 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another may communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system operating an enterprise endpoint embedded subscriber identification module (eSIM) provisioning system comprising:
a processor, memory, and network interface device;
the network interface device for transceiving data with a first endpoint computing device having an embedded universal integrated circuit card (eUICC) capable of programmable selection among a plurality of radio access networks (RANs) including at least one RAN in a 5G New Radio (NR) frequency band;
the processor executing code of an enterprise client management (ECM) system for management of eSIM profiles for plural endpoint computing devices;
the ECM system associating a unique hardware derived device IDentification (DID) based on hardware components of the first endpoint computing device with a level of wireless service to be made available to the first endpoint computing device based on enterprise allocation of service for the first endpoint computing device via the ECM system; and
the network interface device transmitting an eSIM profile to the first endpoint computing device for implementation at the eUICC for the assigned level of service at the first endpoint computing device.

2. The information handling system of claim 1, wherein the network interface device transmits the eSIM profile to the first endpoint device via a boot-strap wireless network connection.

3. The information handling system of claim 1, wherein the network interface device communicates with the first endpoint device via a boot-strap wireless network connection for receiving a periodic wireless check-in from the first endpoint device of unique DID and updated operation condition of the first endpoint device.

4. The information handling system of claim 1 further comprising:
the ECM system associating the unique DID of the first endpoint computing device with a level of wireless service to be made available to the first endpoint computing device based on a personal profile assigned to the unique DID and received operating condition of the first endpoint device via the enterprise allocation of service for the first endpoint computing device.

5. The information handling system of claim 1 further comprising:
the ECM system modifying association of the unique DID of the first endpoint computing device with a second level of wireless service to be made available to the first endpoint computing device based on enterprise allocation of service for the first endpoint computing device due to a received operating condition indicating a changed user identification logged into the first endpoint device.

6. The information handling system of claim 1 further comprising:
the ECM system modifying association of the unique DID of the first endpoint computing device with a second level of wireless service to be made available to the first endpoint computing device based on enterprise allocation of service for the first endpoint computing device due to a received operating condition indicating changed operation location of the first endpoint device.

7. The information handling system of claim 1 further comprising:
a secure memory for storing eSIM profiles including the unique DID of plural endpoint devices and corresponding assigned level of wireless service to be made available to the plural endpoint computing devices.

8. A method for operating an enterprise endpoint embedded subscriber identification module (eSIM) provisioning system comprising:
receiving data including a unique hardware derived device IDentification (DID) identifying a first endpoint computing device and an operating condition of the first endpoint computing device via a network interface device of an information handling system, where the unique DID is derived from encrypted serial numbers of hardware components of the first endpoint computing device;
executing code of an enterprise client management (ECM) system, via a processor, for management of eSIM profiles for plural endpoint computing devices;
associating the received unique DID with a level of wireless service to be made available to the first endpoint computing device based on enterprise allocation of service for the first endpoint computing device via the ECM system; and
transmitting an eSIM profile to the first endpoint computing device for implementation at an embedded universal integrated circuit card (eUICC) at the first endpoint computing device capable of programmable selection among a plurality of radio access networks (RANs) for the assigned level of service designated for the first endpoint computing device.

9. The method of claim 8, wherein the network interface device transmits the eSIM profile to the first endpoint device via a boot-strap wireless network connection.

10. The method of claim 8, wherein the boot-strap wireless network connection is a Wi-Fi wireless network connection.

11. The method of claim 8, wherein the network interface device receives periodic check-in data including a unique DID identifying the first endpoint computing device and an updated operational condition of the first endpoint computing device via a boot-strap wireless network connection.

12. The method of claim 8 further comprising:
modifying, via the ECM system, the association of the unique DID of the first endpoint computing device with a second level of wireless service to be made available to the first endpoint computing device based on enterprise allocation of service for the first endpoint computing device due to a received, updated operating condition indicating a changed user identification logged into the first endpoint device.

13. The method of claim 8 further comprising:
the ECM system modifying association of the unique DID of the first endpoint computing device with a second level of wireless service to be made available to the first endpoint computing device based on enterprise allocation of service for the first endpoint computing device due to a received operating condition indicating changed operation location of the first endpoint device.

14. The method of claim 13, wherein the ECM system association of the unique DID of the first endpoint computing device with the first level of wireless service is made available for the operating condition indicating the first endpoint computing device is at a first enterprise location and the second level of wireless service is made available for the operating condition indicating the first endpoint computing device is at a second, external location.

15. An information handling system operating as a managed endpoint computing device comprising:
a processor and memory;
a wireless network interface device for transceiving data via one or more radio access networks within a wireless wide area network (WWAN);
the processor sending a unique hardware derived device IDentification (DID) derived from encrypted serial numbers of hardware components of the first endpoint computing device and an operating condition of the information handling system to an enterprise endpoint embedded subscriber identification module (eSIM) provisioning system via a boot-strap wireless network;
an embedded universal integrated circuit card (eUICC) capable of programmable selection among a plurality of radio access networks (RANs) including in the WWAN;
the processor receiving an eSIM profile from the enterprise endpoint eSIM provisioning system indicating a wireless service via a first RAN to be available to the information handling system;
the eUICC programmed to authorize the information handling system to access to the first RAN; and
the network interface device accessing the first RAN with the eSIM profile and transmitting data via the first RAN.

16. The information handling system of claim 15, wherein the RAN is a WWAN in a 5G New Radio (NR) frequency band.

17. The information handling system of claim 15, wherein boot-strap wireless network is a Wi-Fi wireless network.

18. The information handling system of claim 15 further comprising:
the processor sending a periodic check-in message to the enterprise endpoint eSIM provisioning system including the unique DID and an updated operating condition via the boot-strap wireless network.

19. The information handling system of claim 15 further comprising:
the processor sending a check-in message to the enterprise endpoint eSIM provisioning system including the unique DID and an updated operating condition indicating changed operation location of the information handling system via the boot-strap wireless network; and
the processor receiving an updated eSIM profile from the enterprise endpoint eSIM provisioning system indicating an updated wireless service via a second RAN to be available to the information handling system based on the changed operating location.

20. The information handling system of claim 15 further comprising:
the processor sending a check-in message to the enterprise endpoint eSIM provisioning system including the unique DID and an updated operating condition indicating changed software application executing on the information handling system via the boot-strap wireless network; and
the processor receiving an updated eSIM profile from the enterprise endpoint eSIM provisioning system indicating an updated wireless service via a second RAN to be available to the information handling system based on the changed software application executing on the information handling system.
